(19) United States
(12) Patent Application Publication
(10) Pub. No.: US 2006/0064315 A1
(43) Pub. Date: Mar. 23, 2006

(54) Budget proposal and reimbursement application processing system and method

(75) Inventors: Jay P. Koch, Mt. Vernon, IL (US); Daniel R. Ruark, Mt. Vernon, IL (US)

Correspondence Address: SENNIGER POWERS, ONE METROPOLITAN SQUARE, 16TH FLOOR, ST LOUIS, MO, 63102, US

(73) Assignee: EcoDigital Development Group, Inc., Woodlawn, IL (US)

(21) Appl. No.: 11/229,369

(22) Filed: Sep. 16, 2005

Related U.S. Application Data
(60) Provisional application No. 60/610,710, filed on Sep. 17, 2004.

(51) Int. Cl. G06Q 99/00

(52) U.S. Cl. 705/1

(57) ABSTRACT

A system and method for managing cost containment within a plurality of projects. Standardized tasks for each of the projects and a schedule for the standardized tasks is defined. Resource data including pricing data for each of the standardized tasks is collected. Based on the defined schedule and the collected data, multi-tiered reimbursement/payment price milestones for each project are developed.

### I.A. BACKGROUND

Agencies such as environmental regulatory agencies are often tasked with the administration of programs that pay for the cleanup of environmental problems. The core mission of such agencies is to enforce environmental regulations, establish environmental cleanup objectives, and guide and monitor environmental cleanup activities. With the advent of funding programs to pay for the costs of such cleanups, these agencies must now also evaluate the costs of the cleanups being performed. These agencies are normally ill-equipped to perform such cost evaluation, as systems and information needed to set valid evaluation guidelines are not available and the agencies themselves are ill-equipped to create such systems themselves, due to a lack of resources, accounting experience, and market pricing data for such specialized services.

This may result in the following problems.

Budget proposals and/or payment applications from consultants may not follow any standardized system of tasks and charges, complicating reviews, hindering consistency and making the setting of justifiable standardized rates difficult, if not impossible.

Price and quantity control initiated by the regulatory agency in the absence of statistically valid price data causes resentment and an adversarial relationship to develop between regulators and consultants, as well as between regulators and site owners.

Regulatory authorities struggle to encourage price competition in states where the financing of cleanup expenses is common. The regulatory perception is that there is no reason for site owners to encourage price competition when they are not required to pay their bills until the fund reimburses them for their cleanup expenses.

Systems of cost control and review that employ standardized rates do not have the feedback systems needed to allow regulators to recognize when price standards are out of date or incorrectly set. They also do not facilitate the flexibility reviewers need to approve scopes of work and expenses that are not in the standardized dataset, nor do they have the means to recognize when a non-standard item has been used a statistically significant number of times and could be standardized.

Regulatory officials do not have a means to compare, side-by-side in the same interface, the proposed price for a non-standard item and the typical price for the same or similar work from nationally-recognized databases such as RS Means.

Regulators often spend valuable time reviewing non-typical items which consultants have failed to justify with additional documentation. Ideally, a means would exist to automatically reject unjustified items and/or bring them into conformance with standards without wasting the reviewer's time.

Agencies shift human resources from the technical review of plans to other functions they are less well-suited to perform, such as accounting and the management of volumes of budgets and payment applications. Fewer personnel applied to technical review results in a backlog of plans awaiting review, short shrift being given to technical review, or both. Accounting review is manual, time-consuming, and inconsistent.

The continued use of physical (paper) budget and pay request forms prevent data from being stored digitally and analyzed for valuable information and trend recognition. Agencies do not have the necessary resources to manually transcribe the vast amounts of cost data they receive in paper form into such a database. This valuable data remains inaccessible for any analytical or organizational use.

The agencies' roles change from simply validating costs for payment to becoming responsible for the balance of funds and minimization of outlays. Cleanup plans become subject to revisions based on cost rather than technical merit, which negatively impacts the site owners' ability to achieve the required cleanup objectives in a timely manner, or at all. Since the incident must eventually meet the cleanup criteria one way or another, the cleanup often costs more in the long run as the work is performed with repeated mobilizations as funding is parceled out in small increments.

A regrettable but very real aspect of agency cost review is that civil servants, with wages below those of the private sector, may unfairly cut technical scopes of work or cut billing rates below normal private industry standards out of a misplaced overt or subconscious sense of envy.

Consultants are confused by regulatory actions because reviewers may not have time to provide statutory or regulatory justification for all the changes they may make to a budget proposal or payment application. This prevents a database of review actions from being created (so that regulations and guidance can be improved over time) and makes the appeals process difficult for consultants (which are unsure on what grounds to appeal an undocumented revision or rejection).

The manual calculation of handling charges by consultants, and the manual checking of such calculations by regulators, introduces a time-consuming and error-prone element into the review of budget proposal and payment applications.

Upon review of budget proposals, many regulatory authorities will specify the exact changes they require in the budget, but will then require the consultant to submit an amended budget to memorialize the required changes. In cases in which the consultant is willing to proceed with the proposed work with the changes required by the regulators, the requirement to resubmit another budget is an unnecessary, time-consuming and costly step.

Cleanup funds are often subject to having balances transferred out for politically expedient purposes such as filling shortfalls in other parts of the government budget. Regulators do not have the reporting tools necessary to “defend” the cleanup funds against these transfers. Such tools could include cash flow projections based in part on funds “committed” to site owners by function of cleanup budget approvals. The net effect is a volatile fund balance, which discourages site owners from undertaking cleanup action and ultimately prevents or delays the very cleanup activities the regulators are supposed to encourage.

Corresponding reference characters indicate corresponding parts throughout the drawings.

### I.B. SUMMARY OF THE INVENTION

In one form, one advantage of the invention is that it provides a system for managing cost containment within a plurality of projects. The system comprises a processor configured to execute computer-executable instructions to:
define standardized tasks for the projects;
collect real-time, market-wide, multi-provider costs data for the standardized tasks for each project; and
based on the collected data, develop statistically valid, multi-tiered reimbursement/payment price milestones for each project while preserving the competitive dynamics of a free-market based system.

In another form, the invention is a system for managing cost containment within a plurality of projects. The system comprises a processor configured to execute computer-executable instructions to:
define standardized tasks for each of the projects;
define a schedule for the standardized tasks;
collect resource data including pricing data for each of the standardized tasks; and
based on the defined schedule and the collected data, develop multi-tiered reimbursement/payment price milestones for each project.

In yet another form, the invention is one or more computer-readable media having computer executable components executable by a computing device. The components include:
A web-based module for creating and submitting proposals;
A web-based module for receiving proposals including tasks, for receiving payment applications for partially completed tasks of the proposal, for receiving payment applications for completed tasks of the proposals and for reviewing and approving received proposals; and
A management module for monitoring received proposals and for responding to received payment applications.

Other features will be in part apparent and in part pointed out hereinafter.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### I.C. BRIEF DESCRIPTION OF THE DRAWINGS

FIGS. 1A and 1B are flow diagrams illustrating the General Overview of the Budgeting Process.

FIG. 2 is a screen shot of a Budget Proposal Submittal Screen.

FIG. 3 is a screen shot of an Issuance of Professional Comments.

FIG. 4 is a screen shot of an Issuance of Owner Comments.

FIG. 5 is a screen shot of an Issuance of Professional Certification.

FIG. 6 is a screen shot of an Issuance of Owner Certification.

FIGS. 7A and 7B are flow diagrams illustrating the Payment Application Process when there is an Approved Budget.

FIG. 8 is a screen shot of a General Overview of the Payment Application Submittal Screen.

FIGS. 9A and 9B are flow diagrams illustrating the General Overview of the Payment Application Process when an Approved Budget is Not Required.

FIGS. 10A and 10B are flow diagrams illustrating the Validation of Budget Proposal Tasks, Resources, Billing Methods and Units of Measure.

FIGS. 10C and 10D are flow diagrams illustrating the Validation of Budget Proposal Time and Materials Task and Resource Pricing.

FIG. 10E is a flow diagram illustrating the Validation of Budget Proposal Lump Sum and Unit of Production Task Pricing.

FIG. 10F is a flow diagram illustrating the Validation of Budget Proposal Task Quantities.

FIG. 11 is a screen shot of an Accounting Reviewer Document Selection Screen.

FIG. 12 is a flow diagram illustrating the Accounting Reviewer Action Steps—Budget Proposals and Budgeted Payment Applications.

FIG. 13 is a screen shot of an Accounting Reviewer Budget Proposal Review Screen.

FIG. 14 is a screen shot of a Technical Reviewer Document Selection Screen.

FIG. 15 is a flow diagram illustrating the Technical Reviewer Action Steps—Budget Proposals.

FIG. 16 is a screen shot of a Technical Reviewer Budget Proposal Review Screen.

FIGS. 17A and 17B are flow diagrams illustrating the Validation of Budgeted Payment Application Tasks, Resources, Billing Methods and Units of Measure.

FIGS. 17C and 17D are flow diagrams illustrating the Validation of Payment Application Time and Materials Task and Resource Pricing.

FIG. 17E is a flow diagram illustrating the Validation of Payment Application Lump Sum and Unit of Production Task Pricing.

FIG. 17F is a flow diagram illustrating the Validation of Budgeted Payment Application Task Quantities.

FIG. 18 is a screen shot of an Accounting Reviewer Budgeted Payment Application Review Screen.

FIG. 19 is a flow diagram illustrating the Technical Reviewer Action Steps—Budgeted Payment Applications.

FIG. 20 is a screen shot of a Technical Reviewer Payment Application Review Screen.

FIG. 21A is a flow diagram illustrating the Validation of Nonbudgetable Payment Application Tasks, Resources, Billing Methods and Units of Measure.

FIG. 21B is a flow diagram illustrating the Validation of Nonbudgetable Payment Application Time and Materials Task and Resource Pricing.

FIG. 21C is a flow diagram illustrating the Validation of Nonbudgetable Payment Application Lump Sum and Unit of Production Task Pricing.

FIG. 21D is a flow diagram illustrating the Validation of Nonbudgetable Payment Application Task Quantities.

FIG. 22 is a flow diagram illustrating the Accounting Reviewer Action Steps—Nonbudgetable Payment Applications.

FIG. 23 is a screen shot of an Accounting Reviewer Nonbudgetable Payment Application Review Screen.

FIG. 24 is a flow diagram illustrating the Technical Reviewer Action Steps—Nonbudgetable Payment Applications.

FIG. 25 is a screen shot of a Technical Reviewer Nonbudgetable Payment Application Review Screen.

FIG. 26 is a flow diagram illustrating the Overview of Appeals Process.

FIG. 27 is a screen shot of a Budget Review Appeals Documentation Screen.

FIG. 28 is a screen shot of a Payment Application Appeals Documentation Screen.

Corresponding reference characters indicate corresponding parts throughout the drawings.

### II. DETAILED DESCRIPTION OF INVENTION

As an overview, in the embodiment, a system according to the invention manages cost containment within a plurality of projects. In one form, the system is implemented with a processor configured to execute computer-executable instructions. The instructions define standardized tasks and resources for the projects and collect real-time, market-wide, multi-provider costs data for the standardized tasks and resources for each project. Based on the collected data, the system is configured to develop statistically valid, multi-tiered reimbursement/payment price milestones for each project while preserving the competitive dynamics of a free-market based system. Statistical validity means that the pricing is set using processes and calculations that conform to the various laws of statistics. For example, for a given value to have a confidence level of X percent, there must be at least Y number of samples. It would not be statistically defensible or valid to change the price of a task that is proposed using the standard price 1000 times and a non-standard price only once. Competitive dynamics of a free-market based system are preserved because the market may price these tasks and resources as it sees fit. In one embodiment, this system does not fix market pricing so that consultants are free to propose whatever price and/or quantity they wish. When expedited values are exceeded, some justification is required for doing so.

A. Platform

This system is platform-independent and can be accomplished using a variety of database and other software programs.

B. Basic Components and Functionality

1. Work Breakdown Structure

The Work Breakdown Structure (WBS), in conjunction with the Standard Resource Schedule, forms the core of this system. The WBS is a schedule of standardized work tasks that are regularly performed in environmental cleanup work. The WBS contains a task numbering system, descriptive data, and financial data to facilitate automated processes.

In the WBS database table, each task will have at least one record (the original entry) and possibly multiple subsequent entries representing detail changes (description, etc., as described above). The following are some of the key table fields:
Task Number—This will be an identification number used for general use by consultants and the regulatory authority.
Task Description—short name for the task
Billing Method—three choices: Time and Materials (T&M), Unit of Production (UOP) or Lump Sum (LS)
Unit of Measure (UOM)—the billing unit (each, gallon, day, etc.)
EQ—in one embodiment, this value is the Expedited Quantity, a minimum quantity at or below which a LS or UOP task is deemed to meet work quantity requirements and the quantity is therefore not subject to modification of the quantity by a technical review; however, the technical reviewer may still deem the entire task inappropriate and reject its use. This is described in more detail later in the specification.
EUP—required only for LS and UOP tasks. This value is the Expedited Unit Price, a minimum unit price at or below which the task is deemed to meet pricing requirements and is therefore not subject to manual pricing review; the price is auto-approved.
EEP—required only for T&M tasks. This value is the Expedited Extended Price, a total task price at or below which the task is not required to show detailed resource level charge data. At that price, it is not subject to manual pricing review; the task is auto-approved, provided standard resources are used.
Status—two choices: Active or Inactive
Effective Date—date of addition (or of modification, in the case of subsequent records for an existing task); when there is more than one record for a given task, the system will use the record with the most recent Effective Date.
Scope of Work—a long-form description of what work the task encompasses
Regulatory Reference—the specific regulation or statute which drives the need for or specifically requires the task in question to be performed

The system will record the use and characteristics of all non-standard tasks in budget proposals and payment applications. Non-standard tasks are tasks that are either not in the WBS or are in the WBS but have been modified by the consultant prior to submission (one example might be changing the task's billing method). This data will be used to perform statistically valid analyses so that existing tasks can be updated with the latest and most accurate real-world data, including but not limited to appropriate costs, billing methods, and unit of measure. New tasks may be added to the WBS based on their recurrence as non-standard tasks that are proposed and regularly approved for use.

Consultants may create “custom” tasks as they see fit in order to propose tasks not in the WBS. If approved, such tasks will exist only in the approved budget records and approved payment application records for that site and phase, and will not be a part of the WBS unless statistical review and analysis prompts agency administrators to add them to the WBS.

2. Standard Resource Schedule

The Standard Resource Schedule (SRS) is the other fundamental dataset that is used to automate certain processes and provide data for manual reviews when necessary. Resources are the individual charge items that make up a time and materials task. The SRS is to resources what the WBS is to tasks: a list of standardized resources that includes pricing data.

In the SRS database table, each task will have at least one record (the original entry) and possibly multiple subsequent entries representing detail changes (description, etc, as described above). The following are some of the key table fields:
Reference Number—This will be an identification number used for general use by consultants and the regulatory authority.
Industry-Standard Pricing Database Name—This is an optional field intended to record an industry-standard pricing database (for example, RS Means) for which reference pricing is being provided for the resource in question.
Industry-Standard Pricing Database Reference Number—This is an optional field intended to record an industry-standard pricing database reference number if one exists, for that item.
Type—Eight choices: Labor, Equipment, Materials & Supplies, Analysis, Field Purchases, Subcontractors, UOP, or LS.
Description—Short name of resource.
Billing Method—three choices: Time and Materials (T&M), Unit of Production (UOP) or Lump Sum (LS)
Unit of Measure (UOM)—the billing unit (each, gallon, day, etc.)
ERR—This value is the Expedited Resource Rate, which is an acceptable maximum unit price at or below which the item is deemed to meet pricing requirements and is therefore not subject to manual pricing review; the price is auto-approved.
Status—two choices: Active or Inactive
Effective Date—date of addition (or of modification, in the case of subsequent records for an existing task); when there is more than one record for a given resource, the system will use the record with the most recent Effective Date.

The system will record the use and characteristics of all non-standard resources in budget proposals and payment applications. Non-standard resources are resources that are either not in the SRS or are in the SRS but have been modified by the consultant prior to submission (one example might be changing the resource's billing method). This data will be used to perform statistically valid analyses so that existing resources can be updated with the latest and most accurate real-world data, including but not limited to appropriate costs, billing methods, and unit of measure. New resources may be added to the SRS based on their recurrence as non-standard resources that are proposed and regularly approved for use.

Consultants may create “custom” resources as they see fit in order to propose resources not in the SRS. If approved, such resources will exist only in the approved budget records and approved payment application records for that site and phase, and will not be a part of the SRS unless statistical review and analysis prompts program administrators to add them to the SRS.

3. Basic Data Entry

Regulatory agencies collect various pieces of financial and business information about the parties which seek reimbursement from their cleanup funds. Therefore, certain basic information must be entered by the consultant into the system to provide the data and variables needed for budget submittals and payment applications to be entered and processed. This data is entered into web-based forms accessed with a web browser. Depending on the requirements of the regulatory authority, such administrative data may include (but not be limited to):
Consultant Women-owned Business Enterprise status
Consultant Minority-owned Business Enterprise status
Site Owner Tax Identification Number
Site Owner Insurance Information
Site Owner Corporate Status/State of Incorporation

Certain other data must be available from regulatory agency databases, so as to provide needed information for the creation of a valid budget submittal and/or payment application. Linking this invention's data tables to regulatory databases will be accomplished using industry-standard tools and will be performed during the implementation of the system. Such data may include, but not be limited to:
A site tracking number (i.e., “Incident Number”)
A site owner tracking number (i.e., “Generator ID”)
Underground storage tank site number or registration number
Eligibility to receive reimbursement of cleanups expenses
Applicable deductible that must be met prior to reimbursement payments being authorized

Finally, the regulatory authority must create and manage certain user IDs and passwords needed to maintain appropriate security and identification validation throughout the system. These include:
Consultant/Contractor ID and password
Site Owner (“PRP”) ID and password
Certifying Professional ID and password
   4. Budget Submittal and Payment Application Data Entry

This system is designed to handle the entry and submission of both budget proposals and payment applications for agency review and approval. The system is flexible in that payment applications may be submitted in certain circumstances without an approved budget required to be in place. This can easily be expanded to cover all payment applications for use in regulatory jurisdictions where the regulatory agency does not require a pre-approved budget.

All budget proposals and payment applications will be tracked by the combination of incident/phase. “Incident” refers to a unique leak or spill of regulated materials at a specific site, and “phase” refers to a specific and distinct stage of work that can be budgeted and tracked as a single entity. This arrangement allows separate budgets to be developed for each phase of a site cleanup.

A. Budget Submittals

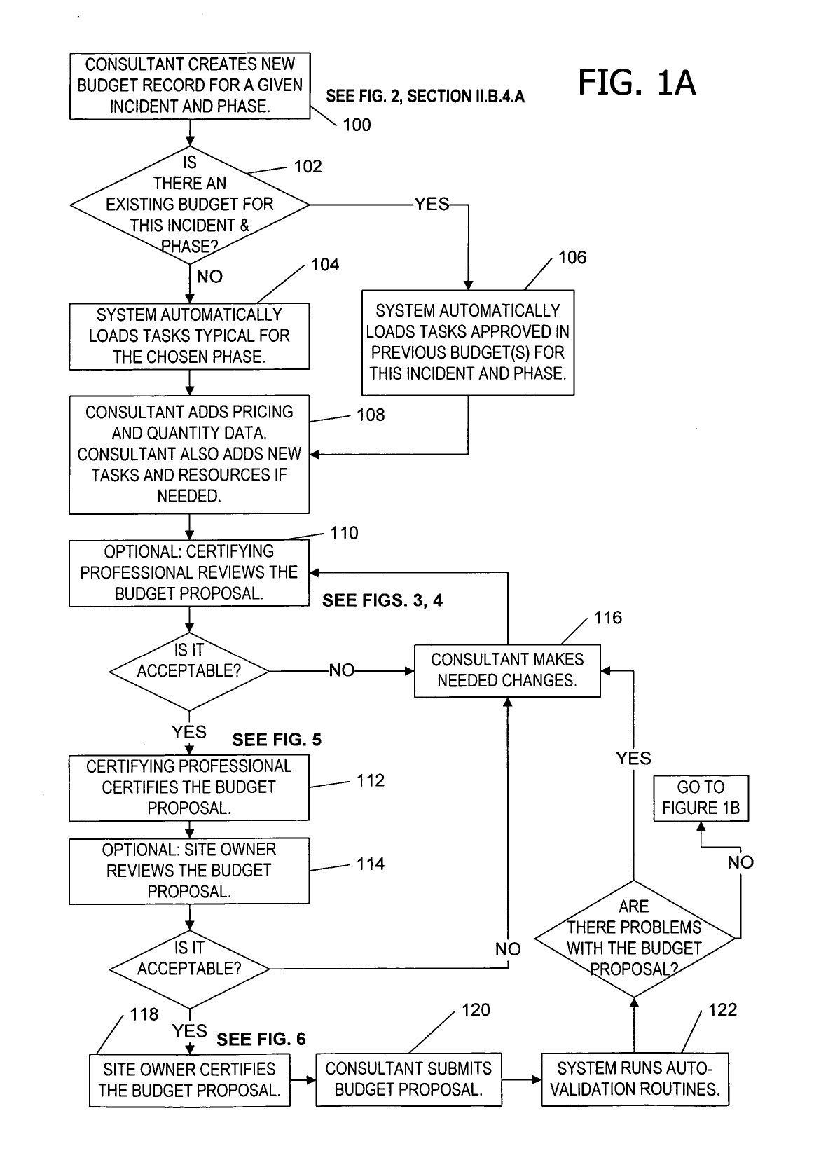

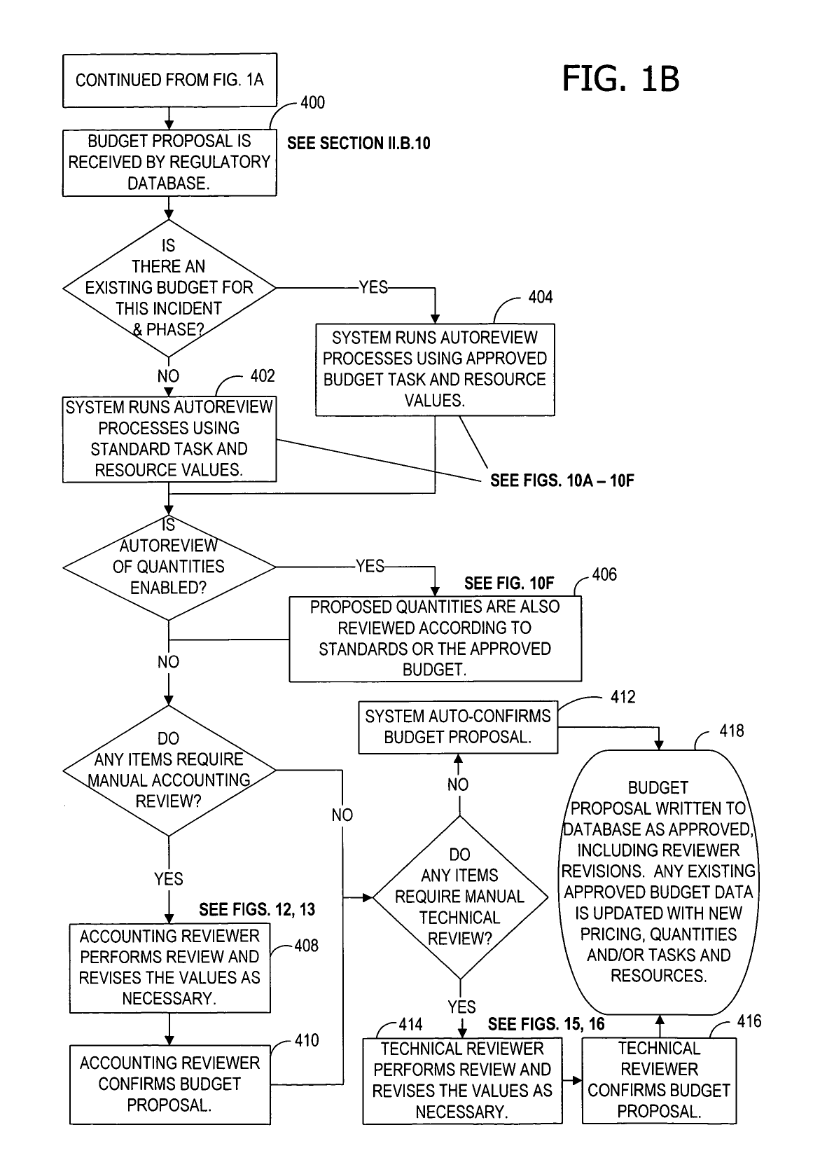

This section will describe the process for submitting a budget proposal to the regulatory authority. An approved budget for proposed work is required in many jurisdictions in which the site owner will be reimbursed for its environmental cleanup expenses. Please refer to FIG. 1A for a general overview of the budgeting process.

The data submission interface that the consultant uses to create, edit and submit budget submittals will be web-based, accessible with a web browser. To perform budget submittal data entry and editing, the user will log in as a consultant. Referring to FIG. 1A, the user will specify the incident, choose the phase of work for which a budget will be proposed, and then create a new budget submittal or open an existing budget submittal draft at 104. A list of tasks which are typically used for the selected phase will be automatically loaded to the screen at 102 through 106. All necessary detail information will be provided, including but not limited to description, billing method and units of measure. The user enters the quantity and unit price, and the system automatically calculates the extended price at 108. In another embodiment, the system could also auto-load the standard unit price, or even a customized unit price specific to the consultant using the system, based on its own fee schedule. Such an embodiment will use a separate maintenance routine to record the consultant's desired fee schedule rates.

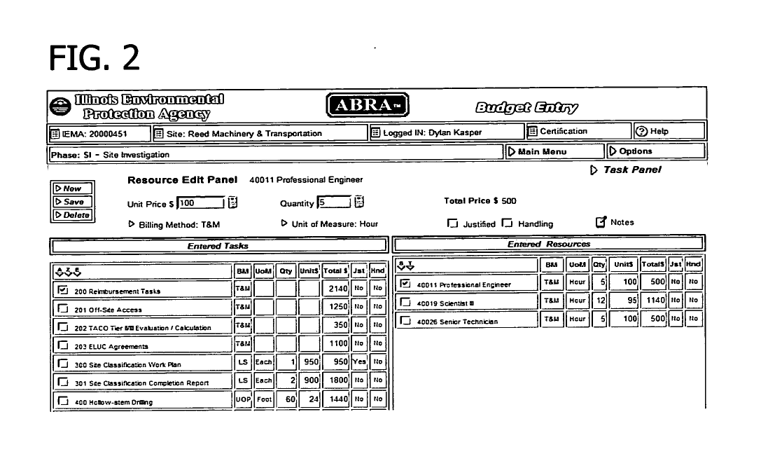

The user will have a checkbox where he or she may indicate that any change he or she makes from the standard characteristics of the task or resource (such as but not limited to a change in units of measure or an exceedence of the expedited price) is “justified.” When the “Justified” checkbox is checked, the user is required to enter a text description of why the change from the standard characteristics of the task or resource was called for. Please refer to FIG. 2 for one embodiment of the budget submittal entry form.

The user may also add tasks and/or resources that do not typically appear in the selected phase, or create wholly customized tasks and/or resources for addition to the budget proposal, if he or she so desires. Such additions are subject to justification.

Each task and resource may have documents attached to it to provide additional information for reviewer consideration (attachments may include but not be limited to scanned documents, spreadsheets, and image files). The consultant will have a field where he or she can indicate that a given expense is subject to handling charges. Such handling charges will be calculated based on formulas provided by the regulatory authorities and are hard-coded into the system during system implementation. In one embodiment of this invention, all items marked eligible for handling charges shall be subject to justification by the consultant.

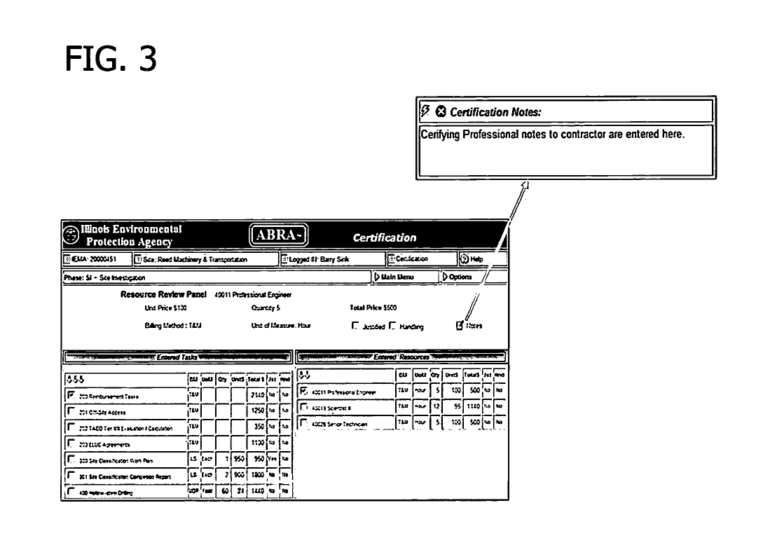

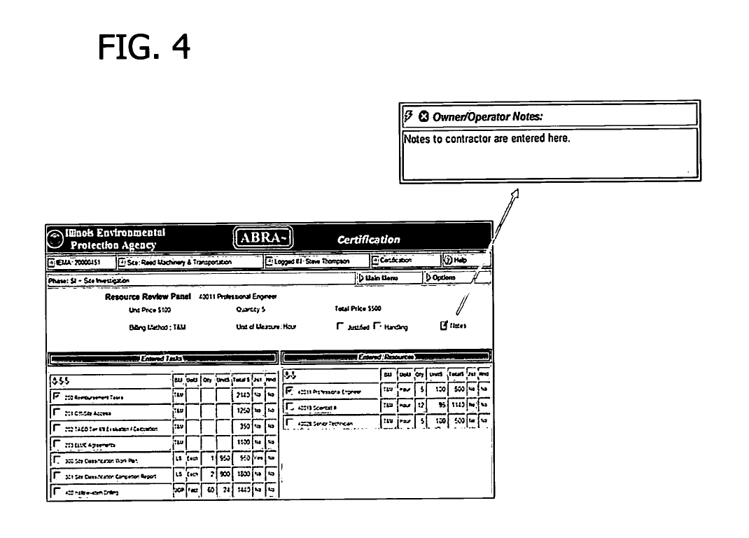

In some regulatory jurisdictions, once the consultant fills out the budget data to his or her satisfaction, he or she must have the information certified at 112, 118 as being acceptable by either or both the site owner and/or a certified professional (certified professional engineer or geologist) before it may be sent to the regulatory authority for review. This invention allows for such review and certification to be performed on-line. Depending on the regulatory requirements, either or both the certifying professional and/or the site owner will have user ID's and passwords assigned to them. They will log on and review a read-only version of the budget submittal. If they find items which they do not believe are correct or appropriate, they may withhold their certification and provide written commentary on a line-item basis. The consultant may then amend the budget proposal to address the stated concerns at 116. The certifying professional and/or site owner may then perform another review. Please refer to FIG. 3: Professional Commenting, and FIG. 4: Owner Commenting.

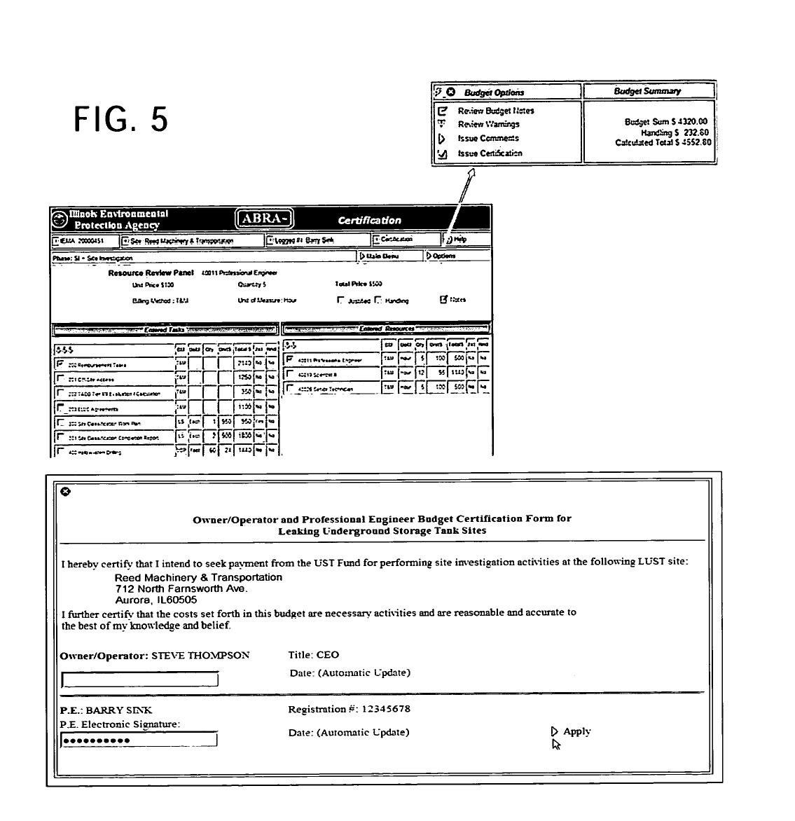

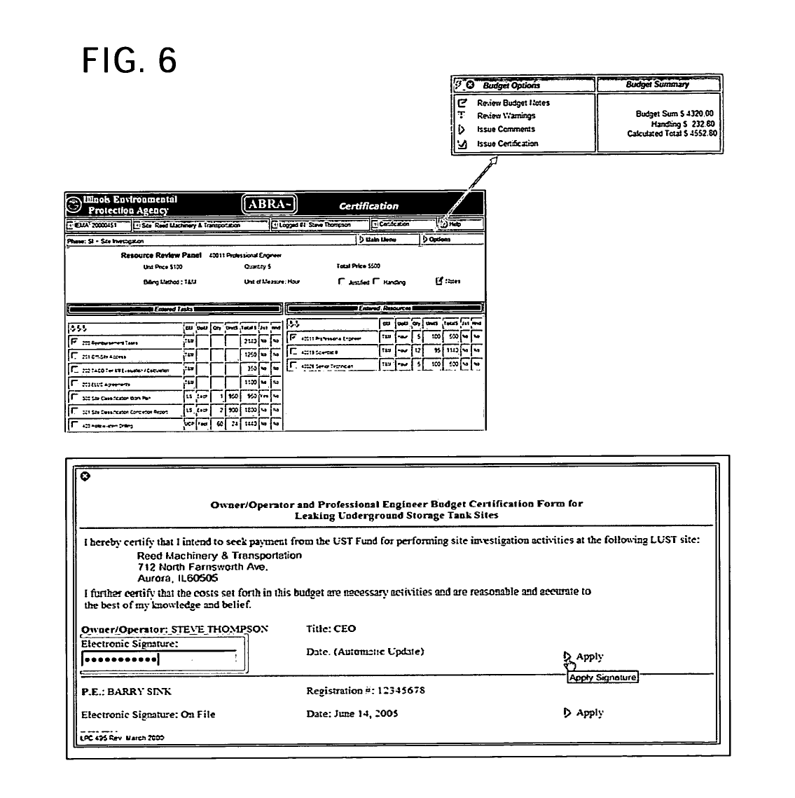

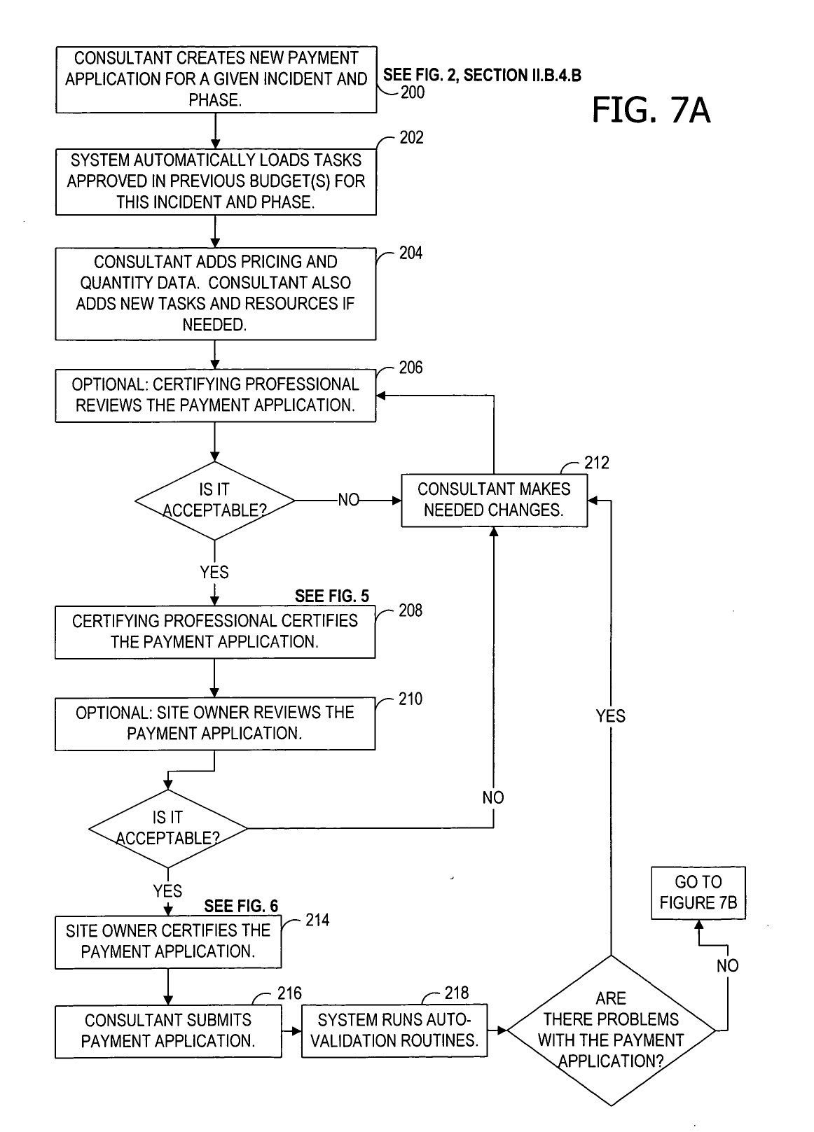

This process of review and comment will continue until the budget submittal is certified (by both the certifying professional 112 and the site owner 118, if both are required). Once the document is certified by either or both the certifying professional at 112 and the site owner at 118, any changes to the document made by the consultant will result in the removal of such certifications. This measure ensures that the document cannot be tampered with after the certifications are applied. In one embodiment of this invention, electronic signatures of the certifying professionals and/or site owners may be captured and used for validation/authentication purposes. Please refer to FIG. 5: Professional Certification, and FIG. 6: Owner Certification.

At this stage, the consultant may submit the budget to the regulatory authority for review at 120 (if certification by the site owner and/or certified professional is required, such certification must be in place before submittal is allowable). Immediately upon the consultant initiating a submittal, the data is checked by the program at 122 to ensure all required information is present (such a check may also be performed by the consultant any time prior to submission). Required data for a budget proposal includes:
Incident Number
Generator ID
Phase (defined by regulatory authority)
Submission/Application Number (assigned by system)
Consultant Name and password (must be in registry)

The following data may be required by the regulatory authority, based on their specific data collection requirements (this is not intended to be a definitive list):
Certification # and password of a certifying professional
Certification # and password of the site owner

If any of the required data is not present, the system will display a message explaining what data is missing, and indicating that the submission process cannot continue without that data. If all of the data required is present, the system will then perform a validation of the individual tasks and resources that have been entered into the form. For tasks and resources which are being proposed for the first time for the given incident and phase, this validation will be based on a comparison of the proposed tasks and resources against their counterparts in the WBS and SRS. For tasks and resources which have been proposed and approved in an earlier budget submittal for the same incident and phase, the comparison will be drawn between the proposed item and the previously approved version of the same item. This validation routine carries out the following tests:
Non-Standard Tasks: These are handled in one of two ways, depending on whether there is already an approved budget for that phase of work:
   No existing approved budget: Non-standard tasks in this case are tasks which are not in the WBS. If the proposed task is not present in the WBS, a pop-up warning to the user will indicate it should be justified. Failure to justify the task will result in its auto-rejection by the regulatory authority.
   An approved budget exists: Non-standard tasks in this case are tasks which are not present in the existing approved budget. If the proposed task is not present in the approved budget, a pop-up warning to the user will indicate it should be justified. Failure to justify the task will result in its auto-rejection by the regulatory authority.
Non-Standard Task Billing Method: If the proposed task billing method is for a task that has never previously been budgeted for this phase, it will be handled as described above for Non-Standard Tasks. If the proposed task billing method is for a budgeted task but differs from the billing method originally approved, a pop-up warning to the user will indicate that the billing method cannot be changed and that failure to use the budgeted billing method will result in the auto-rejection of the proposed task.
Non-Standard Task Unit of Measure: If the proposed task unit of measure is for a task that has never previously been budgeted for this phase, it will be handled as described above for Non-Standard Tasks. If the proposed task unit of measure is for a budgeted task but differs from the unit of measure originally approved, a pop-up warning to the user will indicate that the unit of measure cannot be changed and that failure to use the budgeted unit of measure will result in the auto-rejection of the proposed task.
Non-Standard Resource: These are handled in one of two ways, depending on whether there is already an approved budget for that phase of work:
   No existing approved budget: Non-standard resources in this case are resources which are not in the SRS. If the proposed resource is not present in the SRS, a pop-up warning to the user will indicate it should be justified. Failure to justify the resource will result in its auto-rejection by the regulatory authority.
   An approved budget exists: Non-standard resources in this case are resources which are not present in the existing approved budget. If the proposed resource is not present in the approved budget, a pop-up warning to the user will indicate it should be justified. Failure to justify the resource will result in its auto-rejection by the regulatory authority.
Non-Standard Resource Billing Method: If the proposed resource billing method is for a resource that has never previously been budgeted for this phase, it will be handled as described above for Non-Standard Resources. If the proposed resource billing method is for a budgeted resource but differs from the billing method originally approved, a pop-up warning to the user will indicate that the billing method cannot be changed and that failure to use the budgeted billing method will result in the auto-rejection of the proposed resource.
Non-Standard Resource Unit of Measure: If the proposed resource unit of measure is for a resource that has never previously been budgeted for this phase, it will be handled as described above for Non-Standard Resources. If the proposed resource unit of measure is for a budgeted resource but differs from the unit of measure originally approved, a pop-up warning to the user will indicate that the unit of measure cannot be changed and that failure to use the budgeted unit of measure will result in the auto-rejection of the proposed resource.
Expedited Unit Price Exceedence: if the proposed task unit price exceeds the Expedited Unit Price (“EUP”) or a previously approved budgeted unit price, a pop-up warning to the user will indicate it should be justified. Failure to justify the exceedence will result in the auto-reduction by the regulatory authority of the price to a level equaling the EUP or previously budgeted unit price.
Expedited Extended Price Exceedence (time and materials tasks only): if the proposed task extended (total) price exceeds the Expedited Extended Price (“EEP”) or a previously approved budgeted extended price, a pop-up warning to the user will indicate it is exceeding the EEP and failure to change the item to lower the extended price below the EEP will subject that task to line-item manual review of all resources in that task.
Expedited Resource Rate Exceedence: if the proposed resource unit price exceeds the Expedited Resource Rate (“ERR”) or a previously approved budgeted unit price, a pop-up warning to the user will indicate it should be justified. Failure to justify the exceedence will result in the auto-reduction by the regulatory authority of the unit price to a level equaling the ERR or previously budgeted unit price.
Expedited Quantity Exceedence: if the proposed task quantity, when added to any existing approved quantities for the incident and phase, exceeds the Expedited Quantity (“EQ”), a pop-up warning to the user will indicate it should be justified. Failure to justify the exceedence will result in the auto-reduction by the regulatory authority of the quantity to a level at which the total approved quantity will equal the EQ.
Zero Quantity Task (lump sum and unit rate tasks only): if the task has a quantity of zero, a pop-up warning to the user will indicate failure to enter a quantity greater than zero will result in the task being excluded from the budget submittal.
Zero Quantity Resource: if the resource has a quantity of zero, a pop-up warning to the user will indicate failure to enter a quantity greater than zero will result in the resource being excluded from the budget submittal.
Zero Task Unit Price (lump sum and unit rate tasks only): if the task has a unit price of zero, a pop-up warning to the user will indicate failure to enter a unit price greater than zero will result in the task being excluded from the budget submittal.
Zero Resource Unit Price: if the resource has a unit price of zero, a pop-up warning to the user will indicate failure to enter a unit price greater than zero will result in the resource being excluded from the budget submittal.
Non-Justified Handling Charges: in one embodiment, if the user has marked an item as being eligible for the application of a handling charge, but has failed to mark the item as justified, a pop-up warning to the user will indicate that failure to mark that item as “Justified” will result in the auto-rejection of the application of a handling charge to that item.
Justification Comment Missing: if the user has clicked the Justified checkbox but failed to enter any text into either of the two item-level comment fields, a pop-up warning to the user will indicate that failure to do so will jeopardize the approval of that item upon manual review.
Absence of Tasks: if the user has attempted to submit a budget submittal that doesn't contain any tasks, a pop-up warning to the user will indicate that failure to add any valid tasks to the submittal will prevent its submission.
Absence of Resources (time and materials tasks only): if the user has attempted to submit a budget submittal containing a time and materials task that doesn't contain any resources, a pop-up warning to the user will indicate that failure to add any valid resources to the task will prevent its inclusion with the submission.
Site Total Budget Exceedence: in one embodiment, based on regulatory requirements, a limit may be placed on the total budget approved for any given incident. If the proposed budget total (after auto-rejections and auto-reductions) will exceed that total, a pop-up warning will alter the user that this is the case and the budget cannot be accepted as proposed. The user may amend the budget to prevent the Exceedence.

Please note that justification of non-standard items is completely optional. However, failure to both mark the item as justified and to provide justification in the form of a text comment in at least one of the two comment fields will result (depending on the circumstances) in auto-rejection of the item, auto-reduction of its quantity and/or unit pricing, or the exposure of the item to line-item detailed manual review. The desire to stay within the “norm” as defined by the standards and expedited levels, and thereby avoid such undesirable outcomes, will encourage cost savings and uniformity in submissions.

If the budget proposal passes all automatic checks, a form will open on-screen displaying the budget proposal in an easy-to-read and print format, with a total budget value. It will also indicate a document tracking number for the consultant's use in making reference to the document in other correspondence.

Please note that all of this data is stored in a temporary table in the database. It is not considered complete or valid until it is submitted by the consultant and validated by the system. At that time, it is added to the permanent database of records. Only then is it accessible by the regulatory authority.

B. Payment Applications for Work Requiring an Approved Budget

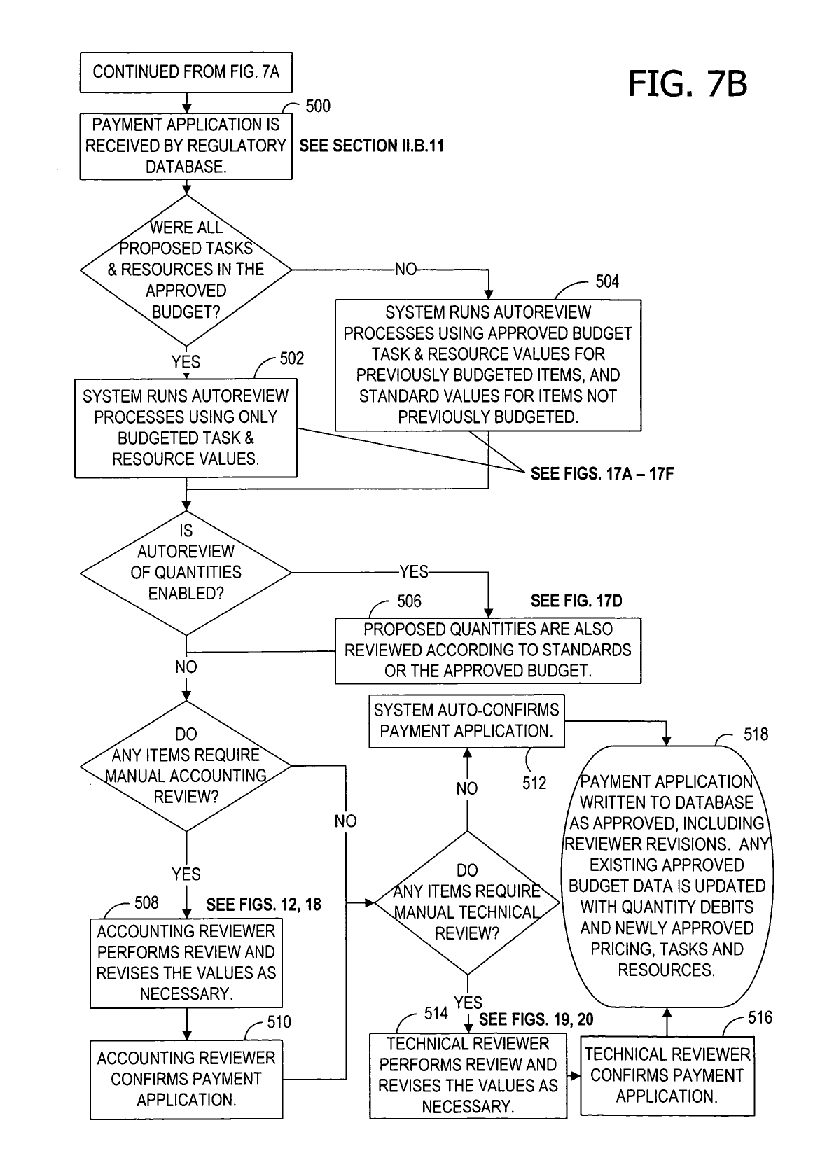

This section will describe the process for submitting a payment application to the regulatory authority against an approved budget. Many jurisdictions require payment applications to meet an approved budget when the site owner applies for reimbursement of its environmental cleanup expenses. Please refer to FIG. 7A for a general overview of the budgeted payment application process.

The consultant will use a web-based data submission interface to submit payment applications which is in many respects similar to the interface used for budget submittals. To perform payment application data entry and editing, the user will log in as a consultant. The user will specify the incident, choose the phase of work for which payment will be requested, and then create a new payment application or open an existing payment application draft at 200. A list of the tasks and resources in the approved budget for that incident and phase will be automatically loaded to the screen at 202. All necessary detail information will be provided, including but not limited to description, billing method, units of measure, and approved unit price. The user enters the quantity (and unit price, if a unit price other than the budgeted unit price is going to be proposed), and the system automatically calculates the extended price at 204.

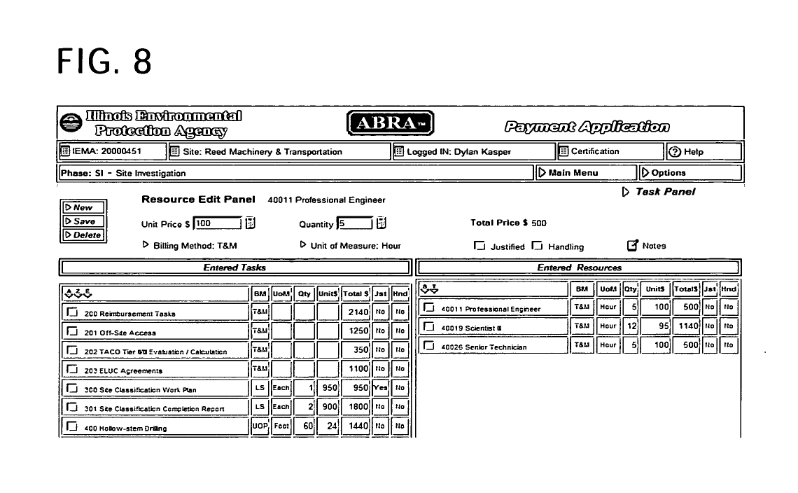

The user will also have a checkbox where he or she may indicate that any change he or she makes from the characteristics of the budgeted task or resource (such as but not limited to a change in units of measure or an exceedence of the budgeted price) is “justified.” When the “Justified” checkbox is checked, the user is required to enter a text description of why the change from the budgeted characteristics of the task or resource was called for. Please refer to FIG. 8 for one embodiment of the payment application entry form.

The user may also add tasks and/or resources that were not in the approved budget, or create wholly customized tasks and/or resources for addition to the payment application, if he or she so desires. Such additions are subject to justification at 204.

Each task and resource may have documents attached to it to provide additional information for reviewer consideration (attachments may include but not be limited to scanned documents, spreadsheets, and image files). The consultant will have a field where he or she can indicate that a given expense is subject to handling charges. Such handling charges will be calculated based on formulas provided by the regulatory authorities and are hard-coded into the system during system implementation. In one embodiment of this invention, all items marked eligible for handling charges shall be subject to justification by the consultant.

In some regulatory jurisdictions, once the consultant fills out the payment application data to his or her satisfaction, he or she must have the information certified at 208, 214 as being acceptable by either or both the site owner and/or a certified professional (certified professional engineer or geologist) before it may be sent to the regulatory authority for review. This invention allows for such review and certification to be performed on-line. Depending on regulatory requirements, either or both the certifying professional and/or the site owner will have user ID's and passwords assigned to them. They will log on and review a read-only version of the payment application at 206, 210. If they find items which they do not believe are correct or appropriate, they may withhold their certification and provide written commentary on a line-item basis. The consultant may then amend the payment application to address the stated concerns at 212. The certifying professional and/or site owner may then perform another review. Please refer to FIG. 3: Professional Commenting, and FIG. 4: Owner Commenting.

This process of review and comment will continue until the payment application is certified (by both the certifying professional at 208 and the site owner at 214, if both are required). Once the document is certified by either or both the certifying professional and the site owner, any changes to the document made by the consultant will result in the removal of such certifications. This measure ensures that the document cannot be tampered with after the certifications are applied. In one embodiment of this invention, electronic signatures of the certifying professionals and/or site owners may be captured and used for validation/authentication purposes. Please refer to FIG. 5: Professional Certification, and FIG. 6: Owner Certification.

At this stage, the consultant may submit the payment application to the regulatory authority for review at 216 (if certification by the site owner and/or certified professional is required, such certification must be in place before submittal is allowable). Immediately upon the consultant initiating a submittal, the data is checked by the program at 218 to ensure all required information is present (such a check may also be performed by the consultant any time prior to submission). Required data for a payment application includes:
Incident Number
Generator ID
Phase (defined by regulatory authority)
Submission/Application Number (assigned by system)
Consultant Name and password (must be in registry)
Billing Period Start Date
Billing Period End Date
Final Submittal Indicator (yes/no; indicates if this submittal is the last for the indicated phase)

The following data may be required by the regulatory authority, based on their specific data collection requirements (this is not intended to be a definitive list):
Certification # and password of a certifying professional
Certification # and password of the site owner

If any of the required data is not present, the system will display a message explaining what data is missing, and indicating that the submission process cannot continue without that data. If all of the required data is present, the system will then perform a validation of the individual tasks and resources that have been entered into the form. For tasks and resources which have been proposed and approved in an earlier budget submittal for the same incident and phase, the comparison will be drawn between the proposed item and the budgeted version of the same item. For tasks and resources which are being proposed in the payment application but which were not previously budgeted for the same incident and phase, this validation will be based on a comparison of the proposed tasks and resources against their counterparts in the WBS and SRS. This validation routine carries out the following tests:
Non-Standard Tasks: These are handled in one of two ways, depending on whether there is already an approved budget for that phase of work.
   No existing approved budget: Non-standard tasks in this case are tasks which are not in the WBS. If the proposed task is not present in the WBS, a pop-up warning to the user will indicate it should be justified. Failure to justify the task will result in its auto-rejection by the regulatory authority.
   An approved budget exists: Non-standard tasks in this case are tasks which are not present in the existing approved budget. If the proposed task is not present in the approved budget, a pop-up warning to the user will indicate it should be justified. Failure to justify the task will result in its auto-rejection by the regulatory authority.
Non-Standard Task Billing Method: If the proposed task billing method is for a task that has never previously been budgeted for this phase, it will be handled as described above for Non-Standard Tasks. If the proposed task billing method is for a budgeted task but differs from the billing method originally approved, a pop-up warning to the user will indicate that the billing method cannot be changed and that failure to use the budgeted billing method will result in the auto-rejection of the proposed task.
Non-Standard Task Unit of Measure: If the proposed task unit of measure is for a task that has never previously been budgeted for this phase, it will be handled as described above for Non-Standard Tasks. If the proposed task unit of measure is for a budgeted task but differs from the unit of measure originally approved, a pop-up warning to the user will indicate that the unit of measure cannot be changed and that failure to use the budgeted unit of measure will result in the auto-rejection of the proposed task.
Non-Standard Resource: These are handled in one of two ways, depending on whether there is already an approved budget for that phase of work:
   No existing approved budget: Non-standard resources in this case are resources which are not in the SRS. If the proposed resource is not present in the SRS, a pop-up warning to the user will indicate it should be justified. Failure to justify the resource will result in its auto-rejection by the regulatory authority.
   An approved budget exists: Non-standard resources in this case are resources which are not present in the existing approved budget. If the proposed resource is not present in the approved budget, a pop-up warning to the user will indicate it should be justified. Failure to justify the resource will result in its auto-rejection by the regulatory authority.
Non-Standard Resource Billing Method: If the proposed resource billing method is for a resource that has never previously been budgeted for this phase, it will be handled as described above for Non-Standard Resources. If the proposed resource billing method is for a budgeted resource but differs from the billing method originally approved, a pop-up warning to the user will indicate that the billing method cannot be changed and that failure to use the budgeted billing method will result in the auto-rejection of the proposed resource.
Non-Standard Resource Unit of Measure: If the proposed resource unit of measure is for a resource that has never previously been budgeted for this phase, it will be handled as described above for Non-Standard Resources. If the proposed resource unit of measure is for a budgeted resource but differs from the unit of measure originally approved, a pop-up warning to the user will indicate that the unit of measure cannot be changed and that failure to use the budgeted unit of measure will result in the auto-rejection of the proposed resource.
Expedited Unit Price Exceedence: if the proposed task unit price exceeds the current budgeted unit price for that task (or, for tasks which are being proposed in the payment application for the first time, which exceed the Expedited Unit Price or EUP), a pop-up warning to the user will indicate it should be justified. Failure to justify the exceedence will result in the auto-reduction by the regulatory authority of the price to a level equaling the budgeted unit price (or EUP, for tasks which are being proposed for the first time).
Expedited Extended Price Exceedence (time and materials tasks only): if the proposed task extended (total) price exceeds the current budgeted remaining extended price for that task (or, for tasks which are being proposed in the payment application for the first time, which exceed the Expedited Extended Price, or EEP), a pop-up warning to the user will indicate it is exceeding the current remaining budgeted extended price (or EEP) and failure to change the item to lower the extended price below the current budgeted remaining extended price (or EEP) will subject that task to line-item manual review of all resources in that task.
Expedited Resource Rate Exceedence: if the proposed resource unit price exceeds the current budgeted unit price for that resource (or, for resources which are being proposed in the payment application for the first time, which exceed the Expedited Resource Rate, or ERR), a pop-up warning to the user will indicate it should be justified. Failure to justify the exceedence will result in the auto-reduction by the regulatory authority of the unit price to a level equaling the current budgeted unit price (or ERR, for resources being proposed for the first time).
Expedited Quantity Exceedence: if the proposed task quantity, when added to any existing approved quantities for the incident and phase, exceeds the current remaining budget quantity balance for that task (or, for tasks which are being proposed in the payment application for the first time, which exceed the Expedited Quantity, or EQ), a pop-up warning to the user will indicate it should be justified. Failure to justify the exceedence will result in the auto-reduction by the regulatory authority of the quantity to a level at which the total approved quantity will equal the remaining budget quantity (or EQ, for tasks which are being proposed for the first time).
Zero Quantity Task (lump sum and unit rate tasks only): if the task has a quantity of zero, a pop-up warning to the user will indicate failure to enter a quantity greater than zero will result in the task being excluded from the budget submittal.
Zero Quantity Resource: if the resource has a quantity of zero, a pop-up warning to the user will indicate failure to enter a quantity greater than zero will result in the resource being excluded from the budget submittal.
Zero Task Unit Price (lump sum and unit rate tasks only): if the task has a unit price of zero, a pop-up warning to the user will indicate failure to enter a unit price greater than zero will result in the task being excluded from the budget submittal.
Zero Resource Unit Price: if the resource has a unit price of zero, a pop-up warning to the user will indicate failure to enter a unit price greater than zero will result in the resource being excluded from the budget submittal.
Non-Justified Handling Charges: in one embodiment, if the user has marked an item as being eligible for the application of a handling charge, but has failed to mark the item as justified, a pop-up warning to the user will indicate that failure to mark that item as “Justified” will result in the auto-rejection of the application of a handling charge to that item.
Justification Comment Missing: if the user has clicked the Justified checkbox but failed to enter any text into either of the two item-level comment fields, a pop-up warning to the user will indicate that failure to do so will jeopardize the approval of that item upon manual review.
Absence of Tasks: if the user has attempted to submit a budget submittal that doesn't contain any tasks, a pop-up warning to the user will indicate that failure to add any valid tasks to the submittal will prevent its submission.
Absence of Resources (time and materials tasks only): if the user has attempted to submit a budget submittal containing a time and materials task that doesn't contain any resources, a pop-up warning to the user will indicate that failure to add any valid resources to the task will prevent its inclusion with the submission.
Site Total Payment Application Exceedence: in one embodiment, based on regulatory requirements, a limit may be placed on the total payment approved for any given incident. If the proposed payment application total (after auto-rejections and auto-reductions) will exceed that total, a pop-up warning will alter the user that this is the case and the payment application cannot be accepted as proposed. The user may amend the payment application to prevent the Exceedence.

Please note that justification of non-standard items is completely optional. However, failure to both mark the item as justified and to provide justification in the form of a text comment in at least one of the two comment fields will result (depending on the circumstances) in auto-rejection of the item, auto-reduction of its quantity and/or unit pricing, or the exposure of the item to line-item detailed manual review. The desire to stay within the “norm” as defined by the standards and expedited levels, and thereby avoid such undesirable outcomes, will encourage cost savings and uniformity in submissions.

If the payment application passes all automatic checks, a form will open on-screen displaying the payment application in an easy-to-read and print format, with a total application value. It will also indicate a document tracking number for the consultant's use in making reference to the document in other correspondence.

Please note that all of this data is stored in a temporary table in the database. It is not considered complete or valid until it is submitted by the consultant and validated by the system. At that time, it is added to the permanent database of records. Only then is it accessible by the regulatory authority.

C. Payment Applications for Work that Does not Require an Approved Budget

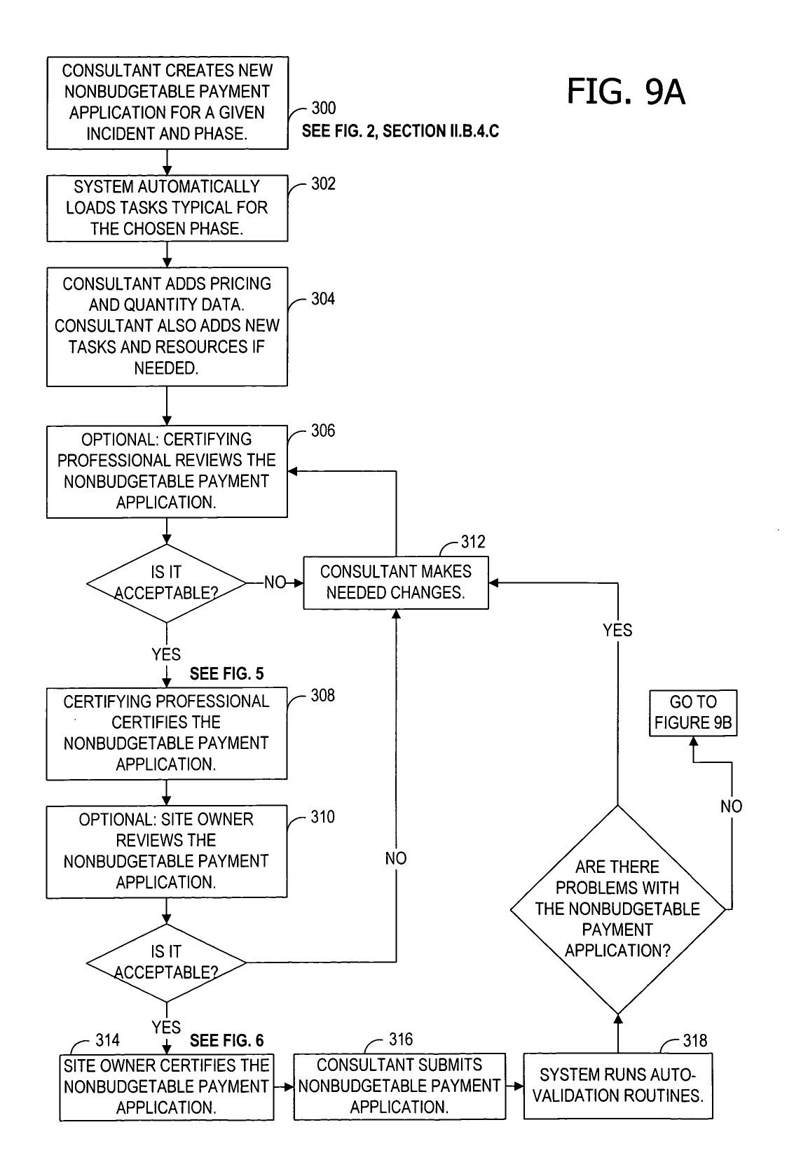

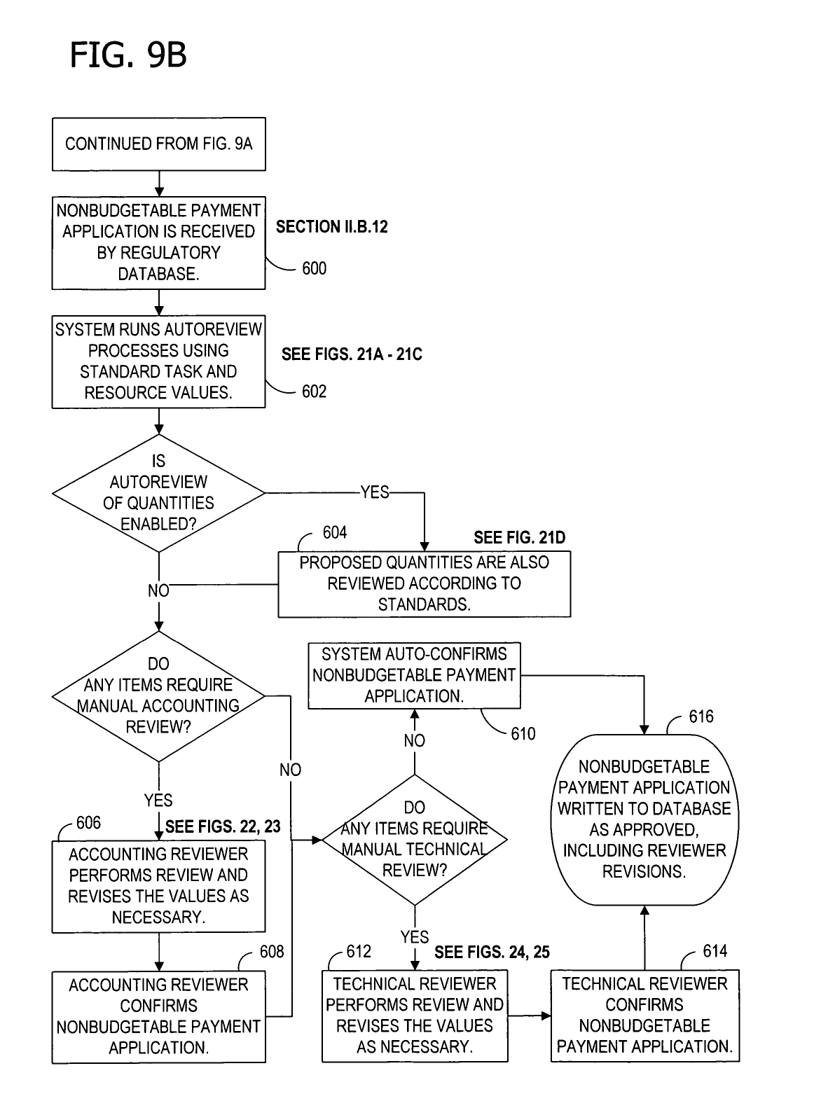

This section will describe the process for submitting a payment application to the regulatory authority for reimbursement of cleanup expenses in cases where an approved budget is not needed. Please refer to FIG. 9A for a general overview of the non-budgetable payment application process.

The consultant will use a web-based data submission interface to submit payment applications which is in many respects similar to the interface used for budget submittals. To perform payment application data entry and editing, the user will log in as a consultant. The user will specify the incident, choose the phase of work for which payment will be requested, and then create a new payment application or open an existing payment application draft at 300. A list of tasks which are typically used for the selected phase will be automatically loaded to the screen at 302. All necessary detail information will be provided, including but not limited to description, billing method and units of measure. The user enters the quantity and unit price, and the system automatically calculates the extended price at 304. In another embodiment, the system could also auto-load the standard unit price, or even a customized unit price specific to the consultant using the system, based on its own fee schedule. Such an embodiment will use a separate maintenance routine to record the consultant's desired fee schedule rates.

The user will also have a checkbox where he or she may indicate that any change he or she makes from the characteristics of the standard task or resource (such as but not limited to a change in units of measure or an exceedence of the standard price) is “justified.” When the “Justified” checkbox is checked, the user is required to enter a text description of why the change from the standard characteristics of the task or resource was called for. Please refer to FIG. 8 for one embodiment of the payment application entry form.

The user may also add tasks and/or resources that do not typically appear in the selected phase, or create wholly customized tasks and/or resources for addition to the budget proposal, if they so desire. Such additions are subject to justification at 304.

Each task and resource may have documents attached to it to provide additional information for reviewer consideration (attachments may include but not be limited to scanned documents, spreadsheets, and image files). The consultant will have a field where he or she can indicate that a given expense is subject to handling charges. Such handling charges will be calculated based on formulas provided by the regulatory authorities and are hard-coded into the system during system implementation. In one embodiment of this invention, all items marked eligible for handling charges shall be subject to justification by the consultant.

In some regulatory jurisdictions, once the consultant fills out the payment application data to his or her satisfaction, he or she must have the information certified at 308, 314 as being acceptable by either or both the site owner and/or a certified professional (certified professional engineer or geologist) before it may be sent to the regulatory authority for review. This invention allows for such review and certification to be performed on-line. Depending on the regulatory requirements, either or both the certifying professional and/or the site owner will have user ID's and passwords assigned to them. They will log on and review a read-only version of the payment application at 306, 310. If they find items which they do not believe are correct or appropriate, they may withhold their certification and provide written commentary on a line-item basis. The consultant may then amend the payment application to address the stated concerns at 312. The certifying professional and/or site owner may then perform another review. Please refer to FIG. 3: Professional Commenting, and FIG. 4: Owner Commenting.

This process of review and comment will continue until the payment application is certified (by both the certifying professional at 308 and the site owner at 314, if both are required). Once the document is certified by either or both the certifying professional and the site owner, any changes to the document made by the consultant will result in the removal of such certifications. This measure ensures that the document cannot be tampered with after the certifications are applied. In one embodiment of this invention, electronic signatures of the certifying professionals and/or site owners may be captured and used for validation/authentication purposes. Please refer to FIG. 5: Professional Certification, and FIG. 6: Owner Certification.

At this stage, the consultant may submit the payment application to the regulatory authority for review at 316 (if certification by the site owner and/or certified professional is required, such certification must be in place before submittal is allowable). Immediately upon the consultant initiating a submittal, the data is checked by the program at 318 to ensure all required information is present (such a check may also be performed by the consultant any time prior to submission). Required data for a payment application includes:
Incident Number
Generator ID
Phase (defined by regulatory authority)
Submission/Application Number (assigned by system)
Consultant Name and password (must be in registry)
Billing Period Start Date
Billing Period End Date
Final Submittal Indicator (yes/no; indicates if this submittal is the last for the indicated phase)

The following data may be required by the regulatory authority, based on their specific data collection requirements (this is not intended to be a definitive list):
Certification # and password of a certifying professional
Certification # and password of the site owner

If any of the required data is not present, the system will display a message explaining what data is missing, and indicating that the submission process cannot continue without that data. If all of the data required is present, the system will then perform a validation of the individual tasks and resources that have been entered into the form. This validation will be based on a comparison of the proposed tasks and resources against their counterparts in the WBS and SRS. This validation routine carries out the following tests:
Non-Standard Task: if the proposed task is not present in the WBS, a pop-up warning to the user will indicate it should be justified. Failure to justify the task will result in its auto-rejection by the regulatory authority.
Non-Standard Task Billing Method: if the proposed task billing method does not match the billing method specified in the WBS, a pop-up warning to the user will indicate it should be justified. Failure to justify the change will result in its auto-rejection by the regulatory authority.
Non-Standard Task Unit of Measure: if the proposed task unit of measure does not match the unit of measure specified in the WBS, a pop-up warning to the user will indicate it should be justified. Failure to justify the change will result in its auto-rejection by the regulatory authority.
Non-Standard Resource: if the proposed resource is not present in the SRS, a pop-up warning to the user will indicate it should be justified. Failure to justify the resource will result in its auto-rejection by the regulatory authority.
Non-Standard Resource Billing Method: if the proposed resource billing method does not match the billing method specified in the SRS, a pop-up warning to the user will indicate it should be justified. Failure to justify the change will result in its auto-rejection by the regulatory authority.
Non-Standard Resource Unit of Measure: if the proposed resource unit of measure does not match the unit of measure specified in the SRS, a pop-up warning to the user will indicate it should be justified. Failure to justify the change will result in its auto-rejection by the regulatory authority.
Expedited Unit Price Exceedence: if the proposed task unit price exceeds the Expedited Unit Price (“EUP”), a pop-up warning to the user will indicate it should be justified. Failure to justify the exceedence will result in the auto-reduction by the regulatory authority of the price to a level equaling the EUP.
Expedited Extended Price Exceedence (time and materials tasks only): if the proposed task extended (total) price exceeds the Expedited Extended Price (“EEP”), a pop-up warning to the user will indicate it is exceeding the EEP and failure to change the item to lower the extended price below the EEP will subject that task to line-item manual review of all resources in that task.
Expedited Resource Rate Exceedence: if the proposed resource unit price exceeds the Expedited Resource Rate (“ERR”), a pop-up warning to the user will indicate it should be justified. Failure to justify the exceedence will result in the auto-reduction by the regulatory authority of the unit price to a level equaling the ERR.
Expedited Quantity Exceedence: if the proposed task quantity, when added to any existing approved quantities for the incident and phase, exceeds the Expedited Quantity (“EQ”), a pop-up warning to the user will indicate it should be justified. Failure to justify the exceedence will result in the auto-reduction by the regulatory authority of the quantity to a level at which the total approved quantity will equal the EQ.
Zero Quantity Task: if the task has a quantity of zero, a pop-up warning to the user will indicate failure to enter a quantity greater than zero will result in the task being excluded from the payment application.
Zero Quantity Resource: if the resource has a quantity of zero, a pop-up warning to the user will indicate failure to enter a quantity greater than zero will result in the resource being excluded from the payment application.
Zero Task Unit Price (lump sum and unit rate tasks only): if the task has a unit price of zero, a pop-up warning to the user will indicate failure to enter a unit price greater than zero will result in the task being excluded from the payment application.
Zero Resource Unit Price: if the resource has a unit price of zero, a pop-up warning to the user will indicate failure to enter a unit price greater than zero will result in the resource being excluded from the payment application.
Non-Justified Handling Charges: in one embodiment, if the user has marked an item as being eligible for the application of a handling charge, but has failed to mark the item as justified, a pop-up warning to the user will indicate that failure to mark that item as “Justified” will result in the auto-rejection of the application of a handling charge to that item.
Justification Comment Missing: if the user has clicked the Justified checkbox but failed to enter any text into either of the two item-level comment fields, a pop-up warning to the user will indicate that failure to do so will jeopardize the approval of that item upon manual review.
Absence of Tasks: if the user has attempted to submit a payment application that doesn't contain any tasks, a pop-up warning to the user will indicate that failure to add any valid tasks to the submittal will prevent its submission.
Absence of Resources (time and materials tasks only): if the user has attempted to submit a payment application containing a time and materials task that doesn't contain any resources, a pop-up warning to the user will indicate that failure to add any valid resources to the task will prevent its inclusion with the application.
Site Total Payment Application Exceedence: in one embodiment, based on regulatory requirements, a limit may be placed on the total payment approved for any given incident. If the proposed payment application total (after auto-rejections and auto-reductions) will exceed that total, a pop-up warning will alter the user that this is the case and the payment application cannot be accepted as proposed. The user may amend the payment application to prevent the Exceedence.

Please note that justification of non-standard items is completely optional. However, failure to both mark the item as justified and to provide justification in the form of a text comment in at least one of the two comment fields will result in auto-rejection of the item, auto-reduction of its quantity and/or unit pricing, or the exposure of the item to line-item detailed manual review. The desire to stay within the “norm” as defined by the standards and expedited levels, and thereby avoid such undesirable outcomes, will encourage cost savings and uniformity in submissions.

If the payment application passes all automatic checks, a form will open on-screen displaying the payment application in an easy-to-read and print format, with a total application value. It will also indicate a document tracking number for the consultant's use in making reference to the document in other correspondence.

Please note that all of this data is stored in a temporary table in the database. It is not considered complete or valid until it is submitted by the consultant and validated by the system. At that time, it is added to the permanent database of records. Only then is it accessible by the regulatory authority.

5. Site Owners Authorization Data

As stated above, some regulatory jurisdictions also require budget submittals and/or payment applications to be certified by the site owner. A table will contain the unique identification and passwords of site owners, so electronic certifications are enabled. This table will be administered by the regulatory authority. The data entry interface for this will be accessible only by authorized regulatory personnel. The table will consist of the following fields:
Number—this is an auto-incremented identification number unique to each site owner
Full Name
Status—two choices: Active or Inactive
Certification Password—generated at random and provided by agency to site owners; this unique password will indicate to the regulatory authority that the site owner has in fact certified the document in question.
Address1—Mailing Address Line
Address 2—Mailing Address Line
City—Mailing Address City
State—Mailing Address State
Zip Code—Mailing Address Zip Code
   6. Site Owner Consultant Authorization Data

A web-based user interface accessible only by Site Owners will be used by them to record the assignment of Consultants to incidents for which the Site Owners are responsible. This interface will also show the start and end dates of such assignments, so that if an incident has several consultants over time, that chain of assignment can be displayed. These records dictate which consultant may work on an incident at a given time; the consultant may be authorized to prepare budget proposals and payment applications using this system, but it will not be able to do so until a Site Owner authorizes it to do so for an incident for which they have responsibility. A given consultant may continue to view budget proposals and payment applications it may have submitted for an incident while it was authorized to do so, even after the incident has been reassigned by the site owner to a new consultant. The old consultant may not submit new records for that incident after a new consultant is assigned, nor may it view new records created by the new consultant. The new consultant is allowed view the old consultant's records, but it may not act on them in any way.

7. Consultant/Contractor Regulatory Authorization Data

A table will contain the unique identification and passwords of consultants or contractors who will be submitting budget proposals and payment applications. This table will be administered by the regulatory authority. The data entry interface for this will be accessible only by regulatory personnel. The table will consist of the following fields:
Consultant/Contractor ID #—assigned by the regulatory authority
Password—generated at random and provided by the regulatory authority to consultants.
Name of Company
Address1—Mailing Address Line
Address 2—Mailing Address Line
City—Mailing Address City
State—Mailing Address State
Zip Code—Mailing Address Zip Code
   8. Consultant User Authorization Data

A table will contain the unique identification and passwords of employees of each consultant and/or certifying professionals hired or employed by the consultants. This table will be administered on a consultant-by-consultant basis by the consultant administrator using a web-based interface accessible only by the consultant. The table will consist of the following fields:
User ID—assigned by the consultant administrator
Password—generated at random and provided by the consultant administrator to its employees.
User Level—In one embodiment of the invention, this is a choice between Administration (empowered to administer the system); Certifying Professional (able only to review and certify budget proposals and payment applications); Project Manager (able to create budget proposals and payment applications and run reporting on same, but not able to certify them); and Senior Management (able to perform all Project Manager level tasks but can also run reporting for all Consultant records). A single user may be assigned two levels (Project Management and Certifying Professional, for example).
Status—Active or Inactive

Another interface will define, based on the input of the Consultant Administrator, what reports may be viewable for each of the chosen user levels).

9. Certifying Professionals Authorization Data

Some regulatory jurisdictions require budget submittals and/or payment applications to be certified by a professional. A table will contain the unique identification and passwords of such professionals, so electronic certifications are enabled. This table will be administered by the regulatory authority. The data entry interface for this will be accessible only by regulatory personnel. The table will consist of the following fields:
Registration Number—this is a professional registration number (most jurisdictions have organizations or agencies which issues professional certifications and provide a registration number to the professional)
Registration Expiration Date—Current expiration date for registration number
Full Name
Profession—this field will indicate to what profession the certifying professional belong (examples include, but are not limited to Professional Engineer or Professional Geologist).
Status—two choices: Active or Inactive
Certification Password—generated at random and provided by agency to professionals; this unique password will indicate to the regulatory authority that the certifying professional has in fact certified the document in question.
Address1—Mailing Address Line
Address 2—Mailing Address Line
City—Mailing Address City
State—Mailing Address State
Zip Code—Mailing Address Zip Code
   10. Budget Proposal Review

This system enables a two-tiered regulatory review approach. The first tier illustrated in FIG. 1B is a financial review of the unit prices associated with the tasks and resources proposed. The second tier illustrated in FIG. 1B is a technical review of the technical merits of the tasks and resources proposed, and the quantities of each.

Accounting reviewers do not see any quantity or extended price data. Technical review is limited to only the appropriateness and quantity of the work proposed. Technical reviewers do not see any unit or extended price data.

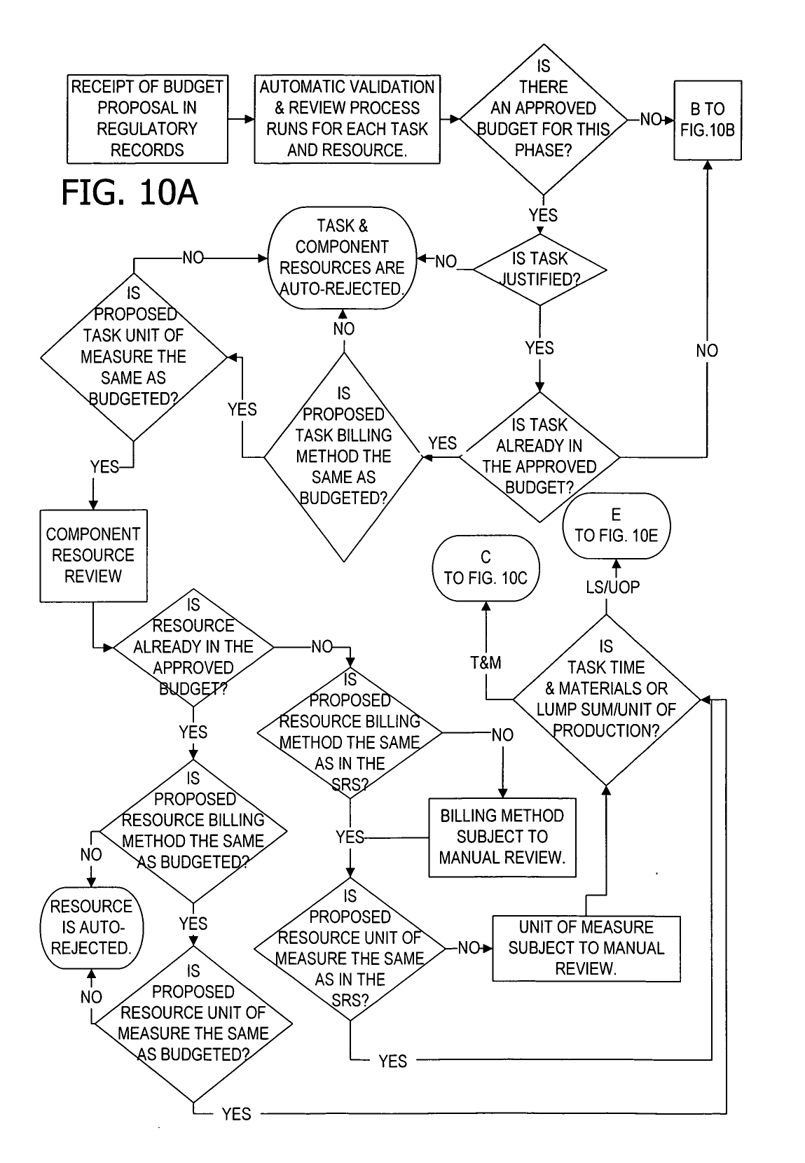

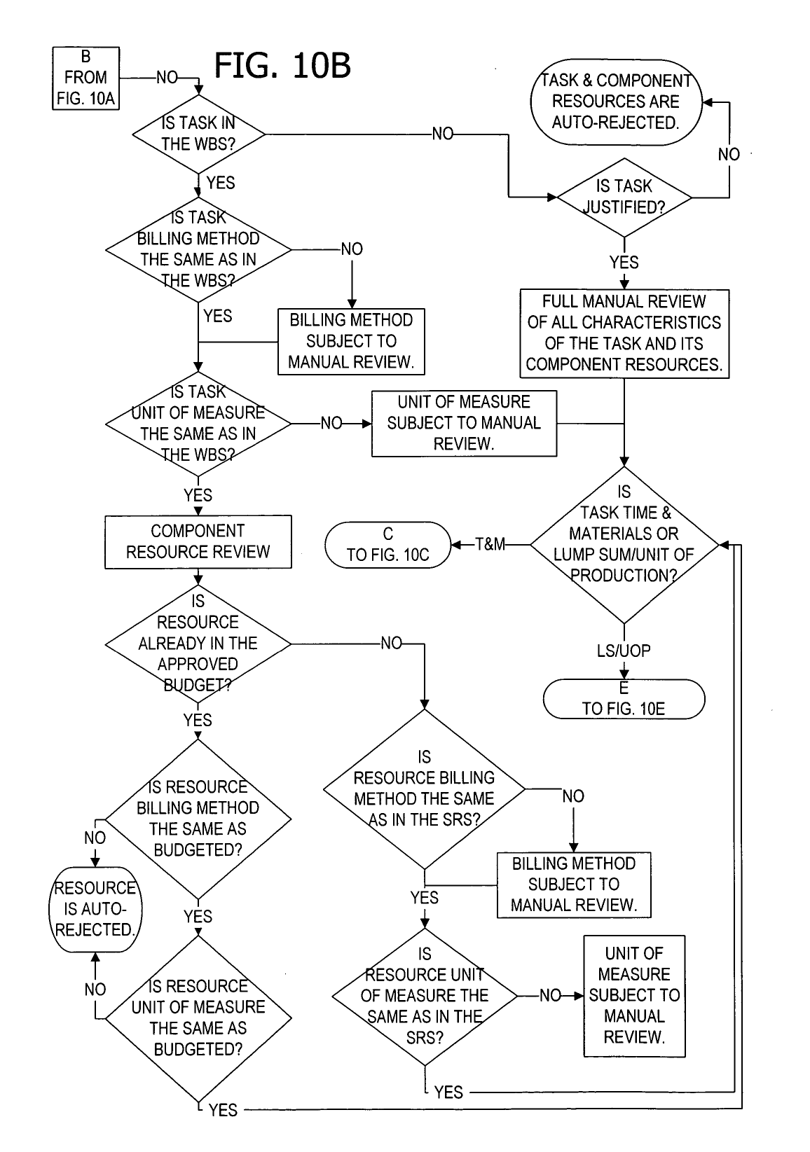

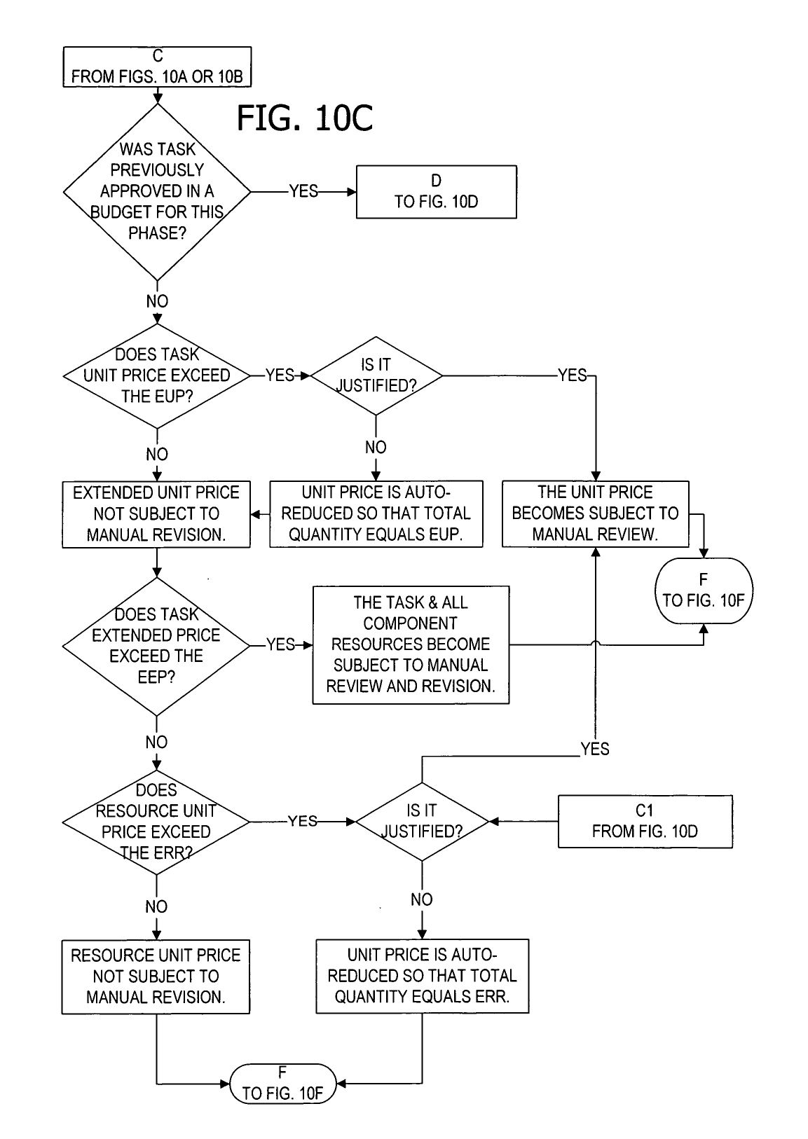

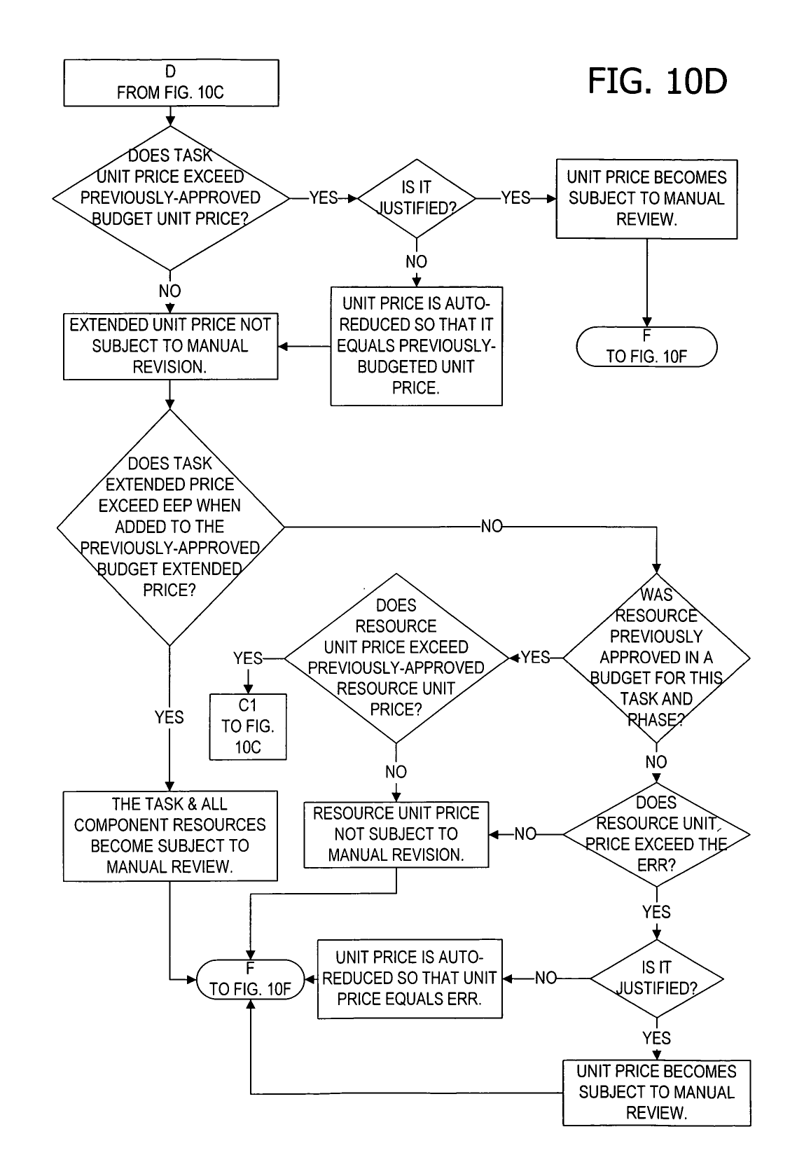

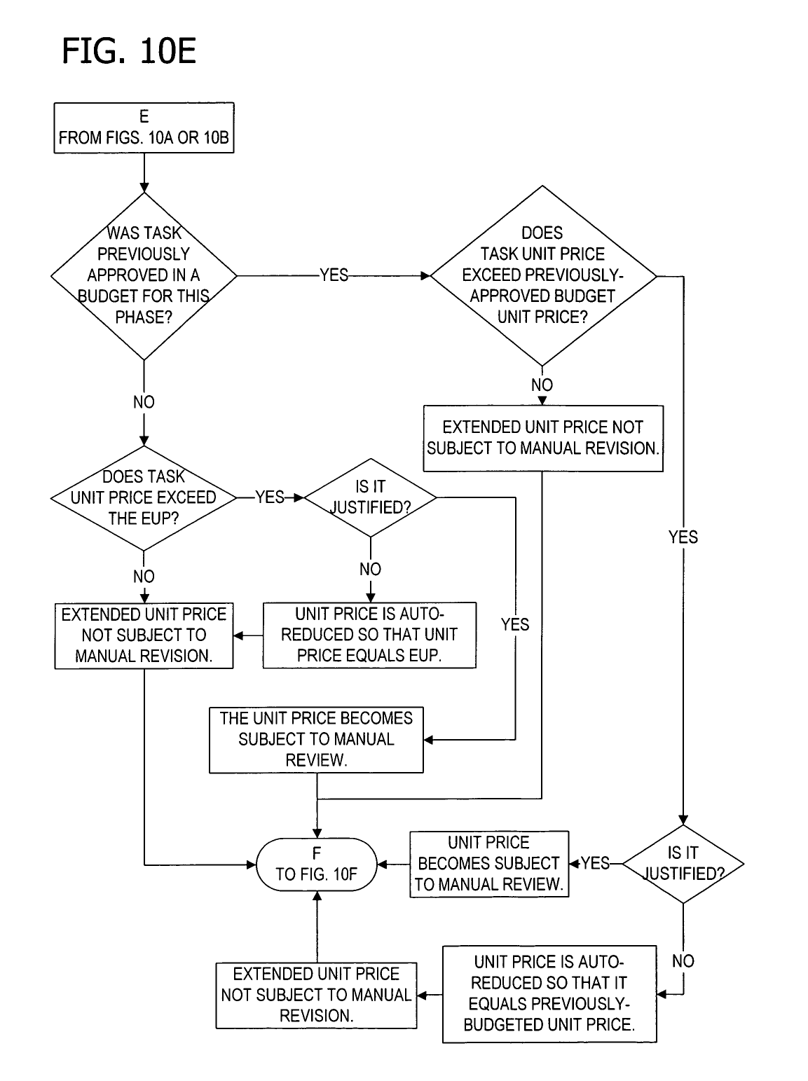

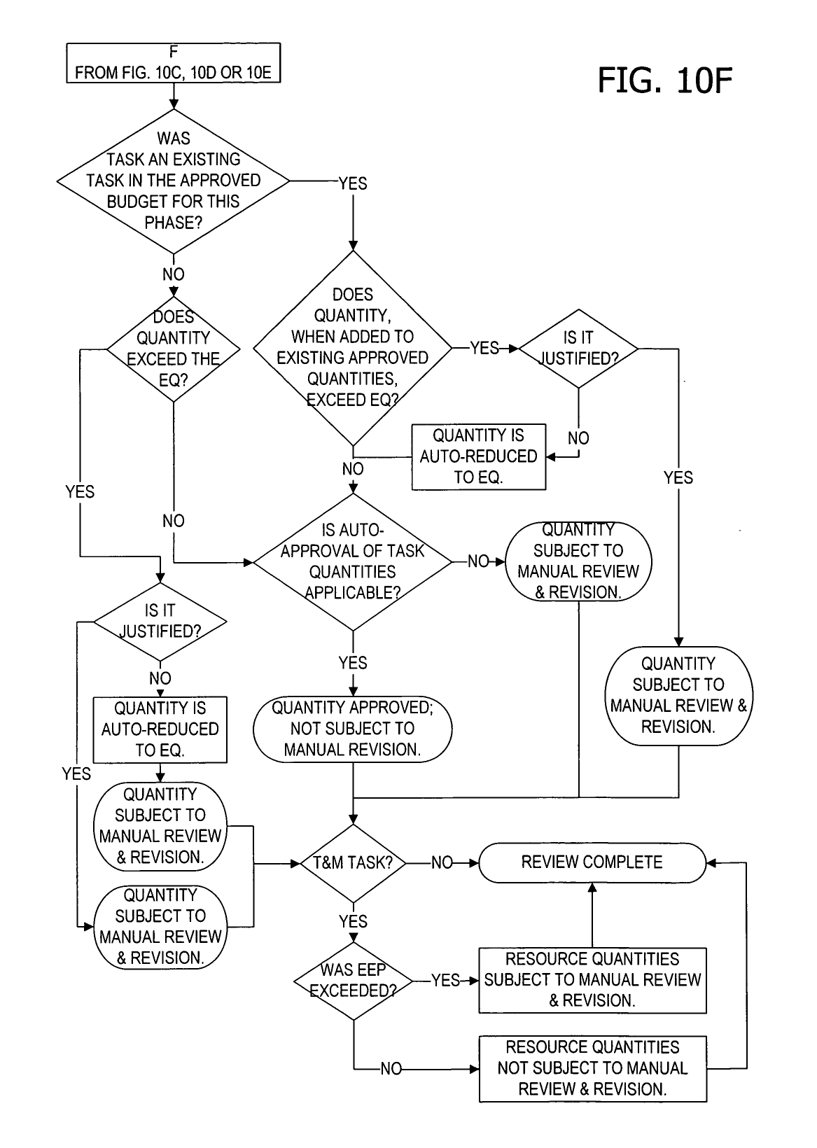

Described below is the budget proposal review process.
a. All budget proposals will be time- and date-stamped.
b. Immediately upon receipt and validation of a budget submittal from the web-based interface at 400, the system will run routines at 402, 404 to search for non-standard pricing, tasks, resources, billing methods and UOMs. Please refer to FIGS. 10A through 10F. These routines are done upon receipt and not later in time because it is the rules and rates in effect at time of receipt that govern budget submittals. The following are validation functions (see FIGS. 10A-10F for embodiments) may be carried out on budget submittals:
   Non-Standard Task: These are handled in one of two ways, depending on whether there is already an approved budget for that phase of work:
      No existing approved budget: Non-standard tasks in this case are tasks which are not in the WBS. Such tasks are auto-rejected if they are not justified, or are subject to manual review if they are justified. Auto-rejected tasks are not reviewable by the regulatory authority.
      An approved budget exists: Non-standard tasks in this case are tasks which are not present in the existing approved budget. Such tasks are auto-rejected if they are not justified, or are subject to manual review if they are justified.
   Non-Standard Task Billing Method: If the proposed task billing method is for a task that has never previously been budgeted for this phase, it will be handled as described above for Non-Standard Tasks. If the proposed task billing method is for a budgeted task but differs from the billing method originally approved, it will be auto-rejected.
   Non-Standard Task Unit of Measure: If the proposed task unit of measure is for a task that has never previously been budgeted for this phase, it will be handled as described above for Non-Standard Tasks. If the proposed task unit of measure is for a budgeted task but differs from the unit of measure originally approved, it will be auto-rejected.
   Non-Standard Resource: These are handled in one of two ways, depending on whether there is already an approved budget for that phase of work:
      No existing approved budget: Non-standard resources in this case are resources which are not in the SRS. Such resources are auto-rejected if they are not justified, or are subject to manual review if they are justified. Auto-rejected resources are not reviewable by the regulatory authority.
      An approved budget exists: Non-standard resources in this case are resources which are not present in the existing approved budget. Such resources are auto-rejected if they are not justified, or are subject to manual review if they are justified.
   Non-Standard Resource Billing Method: If the proposed resource billing method is for a resource that has never previously been budgeted for this phase, it will be handled as described above for Non-Standard Resources. If the proposed resource billing method is for a budgeted resource but differs from the billing method originally approved, it will be auto-rejected.
   Non-Standard Resource Unit of Measure: If the proposed resource unit of measure is for a resource that has never previously been budgeted for this phase, it will be handled as described above for Non-Standard Resources. If the proposed resource unit of measure is for a budgeted resource but differs from the unit of measure originally approved, it will be auto-rejected.
   Expedited Unit Price Exceedence: if the proposed task unit price exceeds the Expedited Unit Price (“EUP”) or, if previously budgeted for that phase, exceeds the previously-approved budgeted unit price, and is not justified, the unit price will be auto-reduced by the system to a level to a level equaling the EUP or previously budgeted unit price. If the task is justified, then the task unit price is subject to manual review.
   Expedited Unit Price Compliance: if the proposed task unit price is less than or equal to the Expedited Unit Price (“EUP”) or, if previously budgeted for that phase, is less than or equal to the previously-approved budgeted unit price, the unit price will be approved as proposed by the system and it will not be subject to manual review.
   Expedited Extended Price Exceedence (time and materials tasks only): if the proposed task extended (total) price exceeds the Expedited Extended Price (“EEP”) or, when added to a previously approved budgeted extended price, that total will exceed the EEP, the task will be subject to line-item manual review of all resources in that task.
   Expedited Extended Price Compliance (time and materials tasks only): if the proposed task extended (total) price is less than or equal to the Expedited Extended Price (“EEP”) or a previously approved budgeted extended price, the task will not be subject to line-item manual review of all resources in that task (provided that the resource unit prices are in compliance and, in one embodiment, none are marked for handling charges)
   Expedited Resource Rate Exceedence: if the proposed resource unit price exceeds the Expedited Resource Rate (“ERR”) or, if previously budgeted for that phase, exceeds the previously-approved budgeted resource rate, and is not justified, the unit price will be auto-reduced by the system to a level to a level equaling the ERR or previously budgeted unit price. If the task is justified, then the resource unit price is subject to manual review.
   Expedited Resource Rate Compliance: if the proposed resource unit price is less than or equal to the Expedited Resource Rate (“ERR”) or, if previously budgeted for that phase, is less than or equal to the previously-approved budgeted resource rate, the unit price will be approved as proposed by the system and it will not be subject to manual review.
   Handling Charges: if, in one embodiment, a task or resource is marked as being eligible for the application of a handling charge, but the consultant failed to mark that item as justified, the system will auto-reject the application of a handling charge to that item. If it is marked as justified, the application of handling will be subject to manual review.
   Expedited Quantity Exceedence: if the proposed task quantity, when added to any existing approved quantities for the incident and phase, exceeds the Expedited Quantity (“EQ”), and it is not justified, the system will auto-reduce the quantity to a level at which the total approved quantity will equal the EQ. If the task is justified, then the task quantity is subject to manual review.
   Expedited Quantity Compliance: if the proposed task quantity, when added to any existing approved quantities for the incident and phase, is less than or equal to the Expedited Quantity (“EQ”), the system may, at the regulatory authority's discretion, auto-approve the quantity at 406 (see Section II.B.13, Auto-Review and Approval of Quantities). Otherwise, the task quantity is subject to manual review.
c. If a budget proposal uses only standard (or previously budgeted) tasks and resources, meets expedited (or previously budgeted) pricing, and meets expedited quantities, it may be auto-approved without manual review at 412 if the system administrator has enabled quantity auto-approval and does not require justification of handling charges. If quantity auto-approval is not enabled, it will be subject to a manual technical review at 414. If justification of handling charges is required, it will also be subject to manual accounting review of those charges at 408.

If a budget proposal does not meet all expedited or budgeted pricing requirements, and/or fails to use completely standard or budgeted tasks and resources (and in one embodiment, fails to have handling charge items marked for justification), then the budget submittal will be subject to manual accounting review as its first manual review at 408. Following manual accounting review, the budget submittal will be subject to manual technical review at 414 (unless auto-approval of quantities is authorized, and the budget has acceptable quantities proposed, in which case there will not be a manual technical review and the budget submittal will be auto-approved after accounting review at 412).

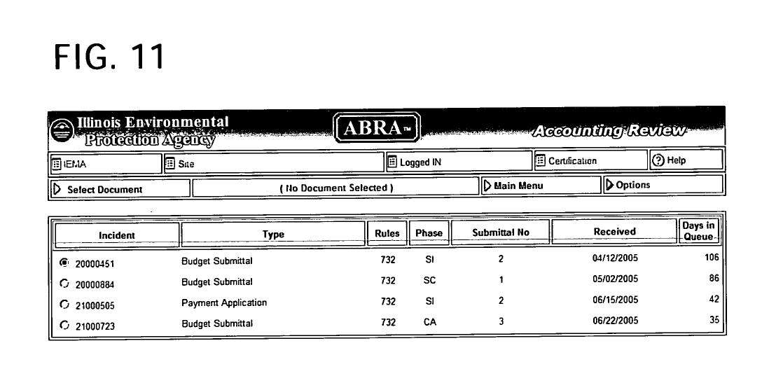

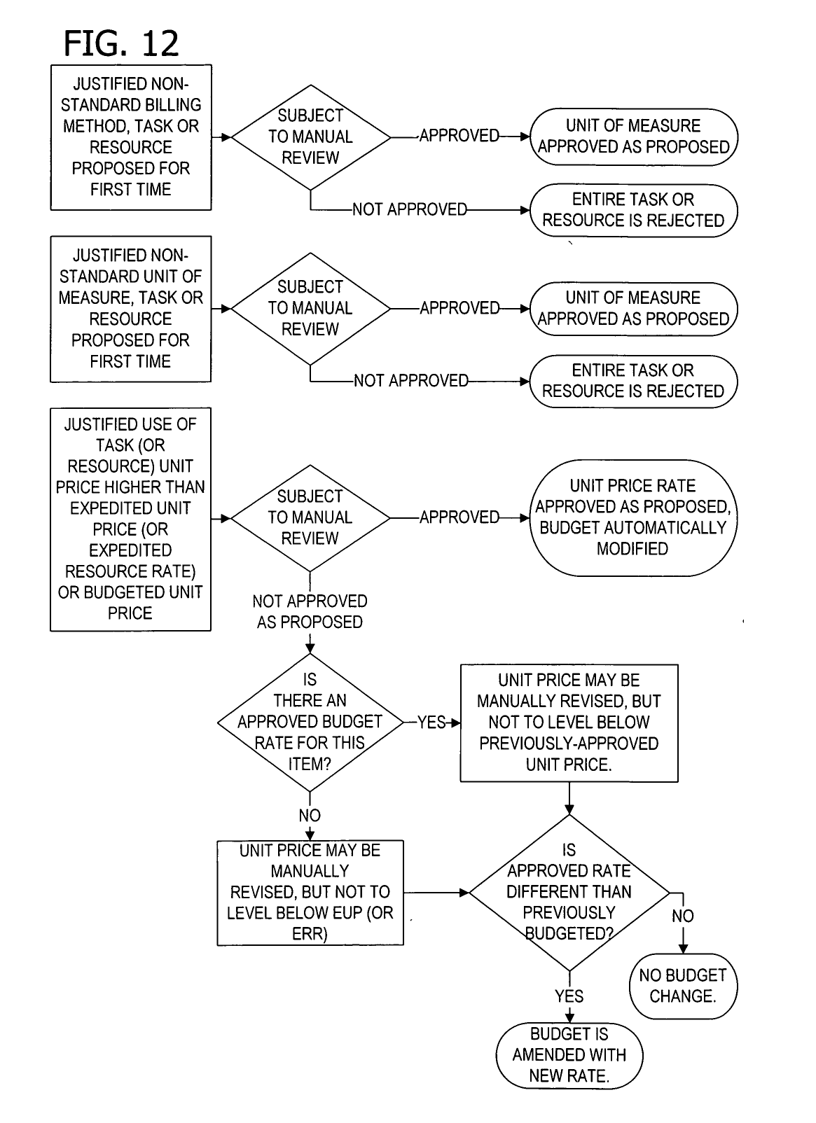

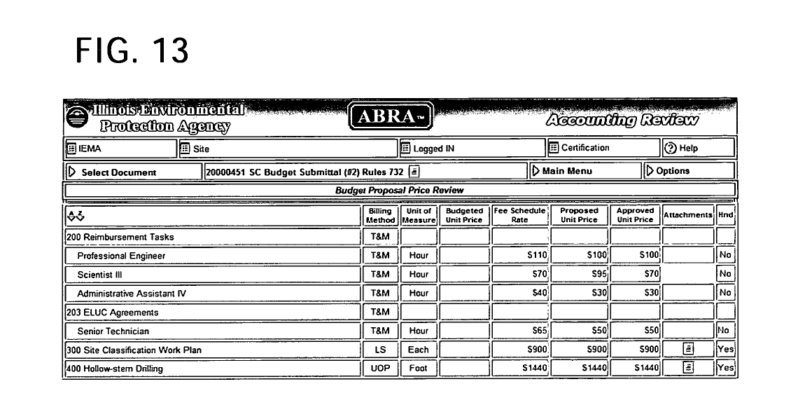

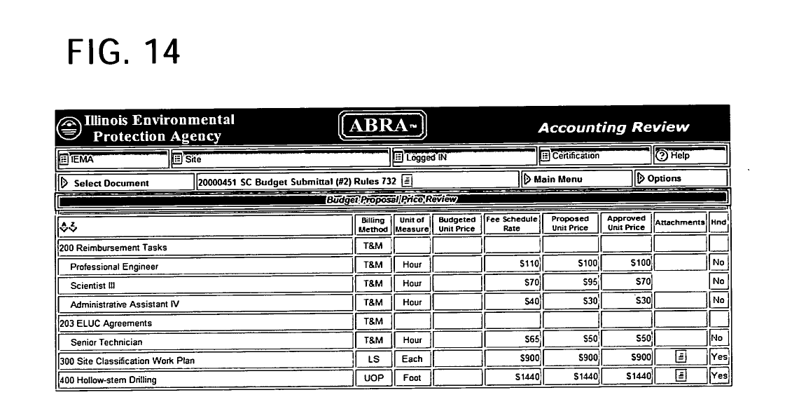

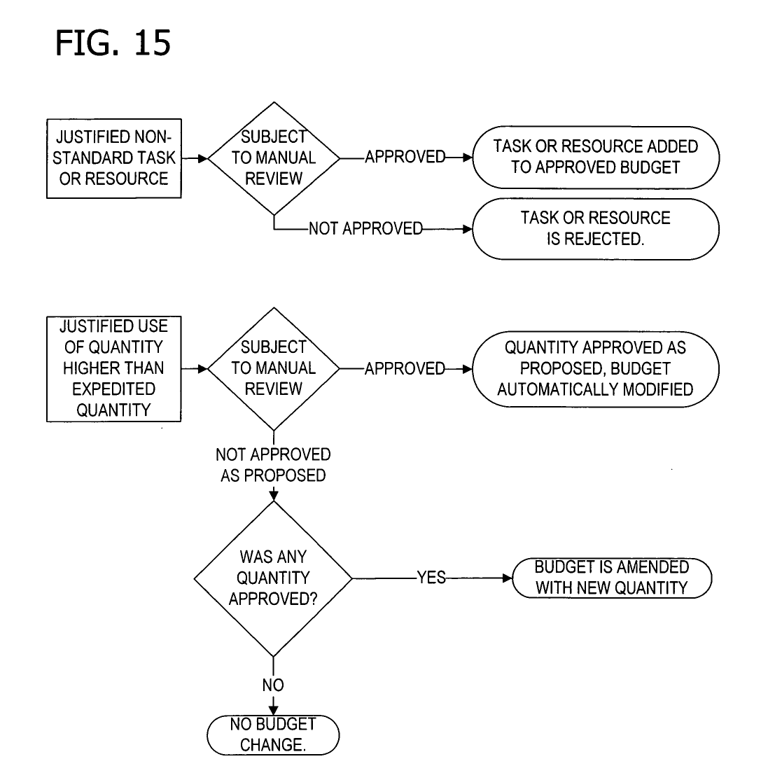

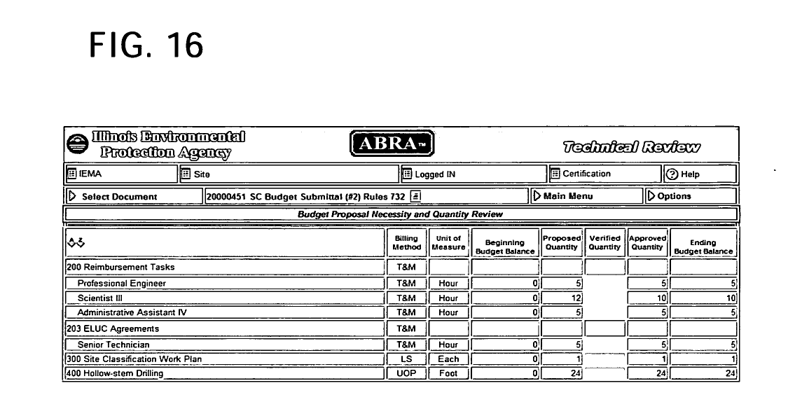

If a budget proposal is subject to both accounting manual review and technical manual review, the accounting review at 408 shall be performed first. The budget proposal will not be available for technical review until the accounting review is completed.
d. Accounting Reviewers will choose budgets for review from a lookup screen that lists all unreviewed budget proposals and payment applications (FIG. 11).
e. Accounting Reviewers may take the following actions during their manual review at 408 (see FIG. 12). These actions are performed from within the Budget Proposal Accounting Review Screen, FIG. 13:
   Justified Non-Standard Task Billing Method: If the proposed task billing method is for a task that has never been budgeted for this phase, it does not match the billing method specified for that task in the WBS, and it is justified, the task will be subject to reviewer approval or rejection based on the merit of the justification provided.
   Justified Non-Standard Task Unit of Measure: If the proposed task unit of measure is for a task that has never been budgeted for this phase, it does not match the unit of measure specified for that task in the WBS, and it is justified, the task will be subject to reviewer approval or rejection based on the merit of the justification provided.
   Justified Non-Standard Resource Billing Method: If the proposed resource billing method is for a resource that has never been budgeted for this phase, it does not match the billing method specified for that resource in the SRS, and it is justified, the resource will be subject to reviewer approval or rejection based on the merit of the justification provided.
   Justified Non-Standard Resource Unit of Measure: If the proposed resource unit of measure is for a resource that has never been budgeted for this phase, it does not match the unit of measure specified for that resource in the SRS, and it is justified, the resource will be subject to reviewer approval or rejection based on the merit of the justification provided.
   Justified Expedited Unit Price Exceedence: if the proposed task unit price exceeds the Expedited Unit Price (“EUP”) or a previously approved budgeted unit price and it is justified, then the reviewer may accept the unit price as proposed, or reduce it to any level he or she may see fit, except that in no case may the task unit price be lowered to a price below that in the WBS or in a previously approved budget for that same task, incident and phase.
   Justified Expedited Resource Rate Exceedence: if the proposed resource unit price exceeds the Expedited Resource Rate (“ERR”) or a previously approved budgeted unit price and it is justified, then the reviewer may accept the unit price as proposed, or reduce it to any level he or she may see fit, except that in no case may the resource unit price be lowered to a price below that in the SRS or in a previously approved budget for that same resource, incident and phase.
   Justified Handling Charges: in one embodiment, if the item is marked as being eligible for the application of a handling charge and it is marked justified, the Accounting Reviewer may approve or deny the application of a handling charge to that item based on their review of the justification for same.
f. Once the Accounting Review is complete, the reviewer may mark the budget submittal as “Confirmed” at 410. This action will make the budget submittal available to the Technical Reviewer for selection and review. If the Accounting Reviewer chooses not to confirm a budget proposal at a given time, he or she may save their edits by clicking a “Save Changes/Hold for Further Review” button. In one embodiment of this invention, doing this will trigger an email to the Consultant notifying them that the budget submittal has been placed on hold. This will enable them, in the event the regulatory authority doesn't contact them first, to follow up with the regulatory authority to see what the problem is.
g. Technical Reviewers will choose budgets for review from a lookup screen that lists all unreviewed budget proposals (FIG. 14). As stated above, budget submittals are not available for technical review until they pass accounting review, if one is required.
h. Technical Reviewers may take the following actions during their manual review at 414 (see FIG. 15). These actions will be performed from within the Budget Proposal Technical Review Screen, FIG. 16:
   Justified Non-Standard Task: If the proposed task is not present in the approved budget for this phase but it is justified, the task will be subject to approval or denial of its use, based on the technical judgment of its necessity by the technical reviewer.
   Justified Non-Standard Resource: if the proposed resource is not present in the approved budget for this phase but it is justified, the resource will be subject to approval or denial of its use, based on the technical judgment of its necessity by the technical reviewer.
   Justified Expedited Quantity Exceedence: if the proposed task quantity, when added to any existing approved quantities for the incident and phase, exceeds the Expedited Quantity (“EQ”), but it is justified, the reviewer may accept the quantity as proposed, or reduce it to any level he or she may see fit, except that in no case may the resource unit price be lowered to a quantity which, when added to any previously approved quantities for this task, incident and phase, will be below the EQ.
i. If the Technical Reviewer chooses not to confirm a budget proposal at a given time, he or she may save their edits by clicking a “Save Changes/Hold for Further Review” button. In one embodiment of this invention, doing this will trigger an email to the Consultant notifying them that the budget submittal has been placed on hold. This will enable them, in the event the regulatory authority doesn't contact them first, to follow up with the regulatory authority to see what the problem is.
j. Handling charges will not be displayed, as they are solely a function of which, if any, resources are marked as eligible for handling by the consultant. Application of handling charges is done by the system, not by the consultant or by the regulatory authority.
k. When any manual modification or rejection of a budget proposal item is made by either an accounting or a technical reviewer, the reviewer is required to enter a justification for taking that action. The budget review cannot be confirmed until all such changes are accompanied by reviewer justification.
l. Once the final review is complete (Accounting and/or Technical, as the case may be), the reviewer will confirm the budget at 416. This will create a new record in the database. Quantities approved will be updated and changes in task and resource characteristics will be recorded at 418. The original budget proposal record will still be in the database in its original form, so reporting and analysis may be performed on the basis of proposed versus approved record(s). A record is created even if every component of a budget submittal is rejected.
m. A budget may also be marked as “withdrawn” during either Accounting or Technical review if the consultant asks that it no longer be considered. The records is still retained but is flagged as “withdrawn.” Withdrawn budget submittals may, at the regulatory administrator's option, be excluded from statistical analyses and reporting.
   11. Payment Application Review for Work Requiring an Approved Budget

This system enables a two-tiered regulatory review approach. The first tier illustrated in FIG. 7B is a financial review of the unit prices associated with the tasks and resources proposed for payment. The second tier illustrated in FIG. 7B is a technical review of the technical merits of the tasks and resources proposed for payment, and the quantities of each.

Accounting reviewers do not see any quantity or extended price data. Technical review is limited to only the confirmation that work for which payment is requested was necessary, was actually performed in the quantities indicated, and that the quantities indicated were reasonable and necessary. Technical reviewers do not see any unit or extended price data.

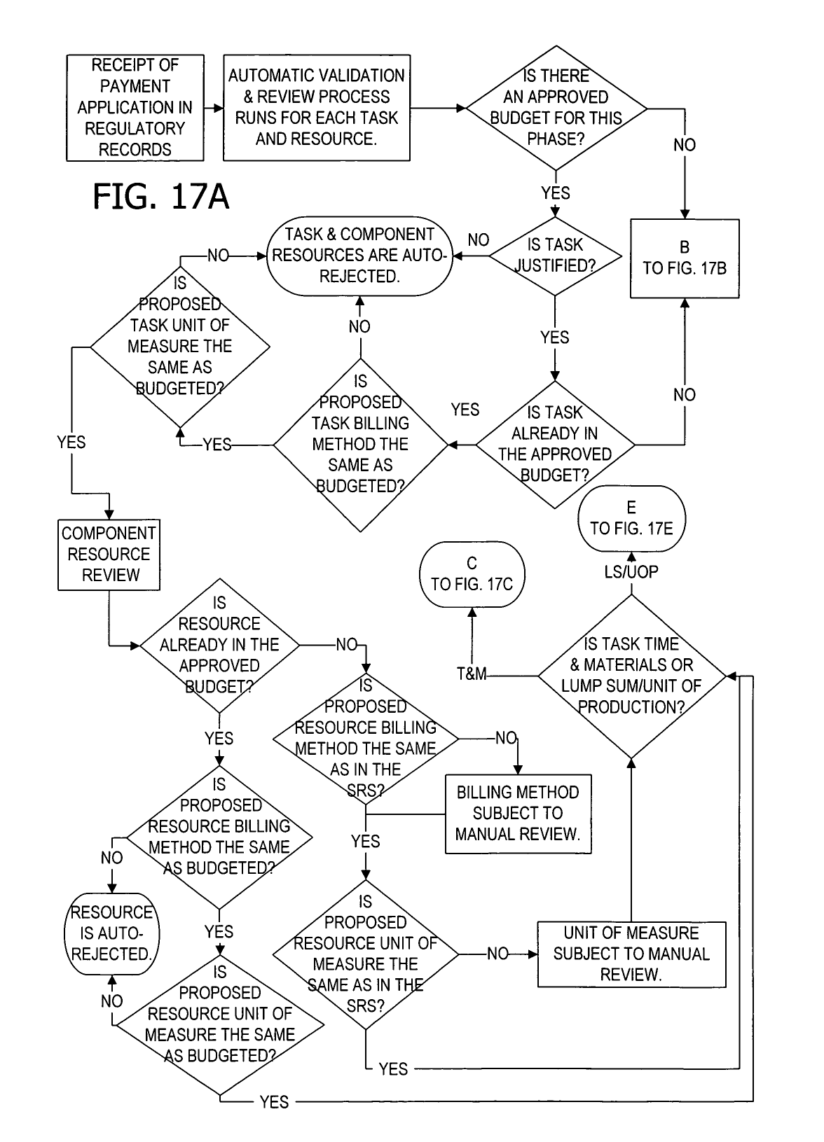

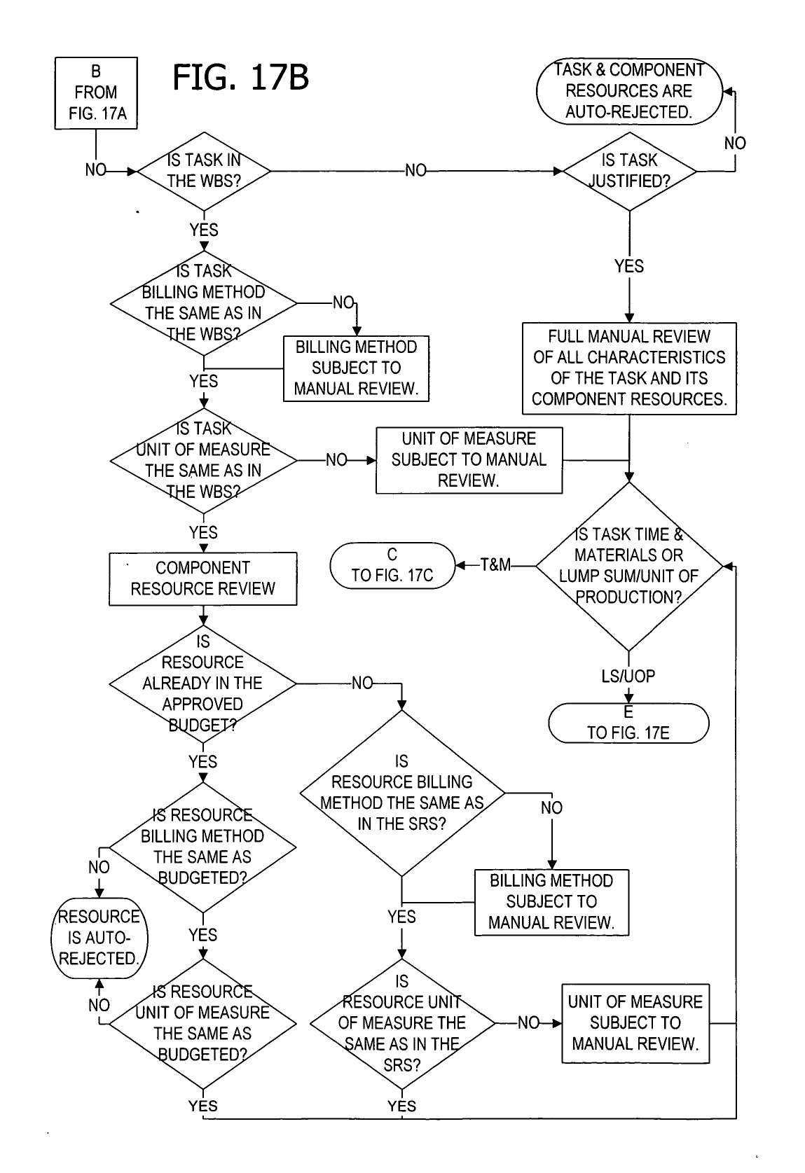

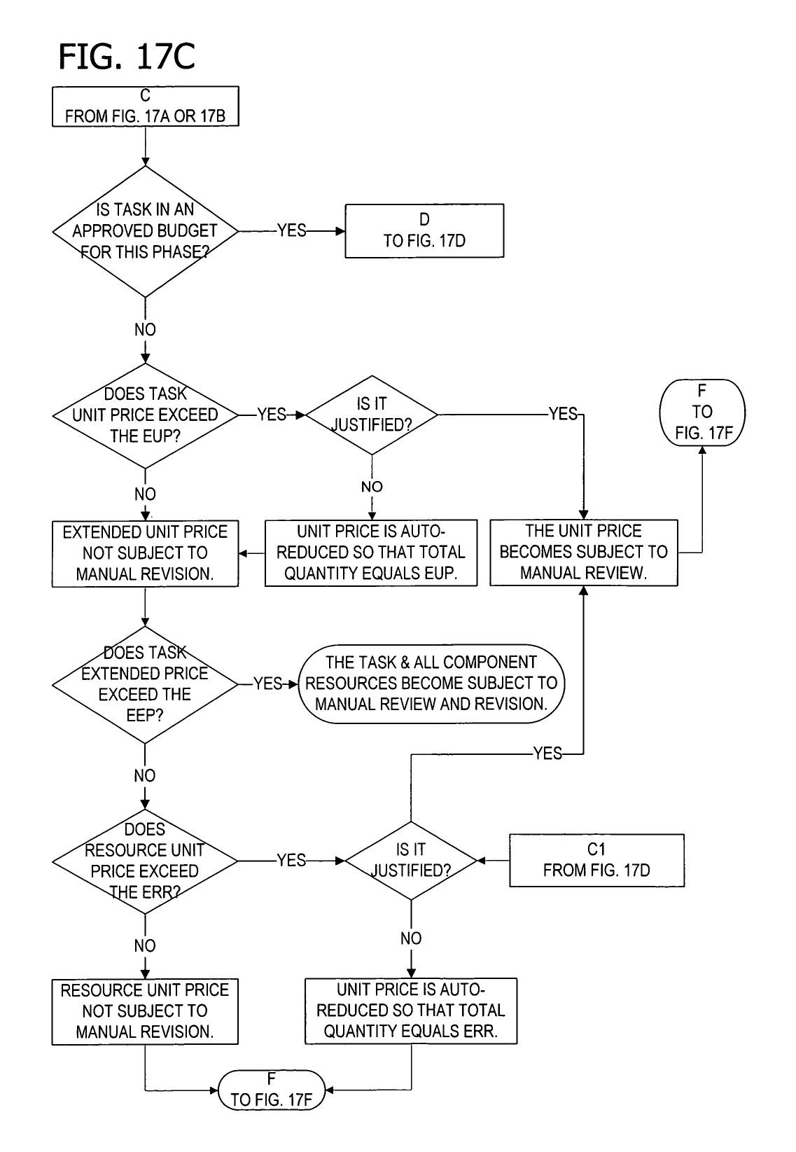

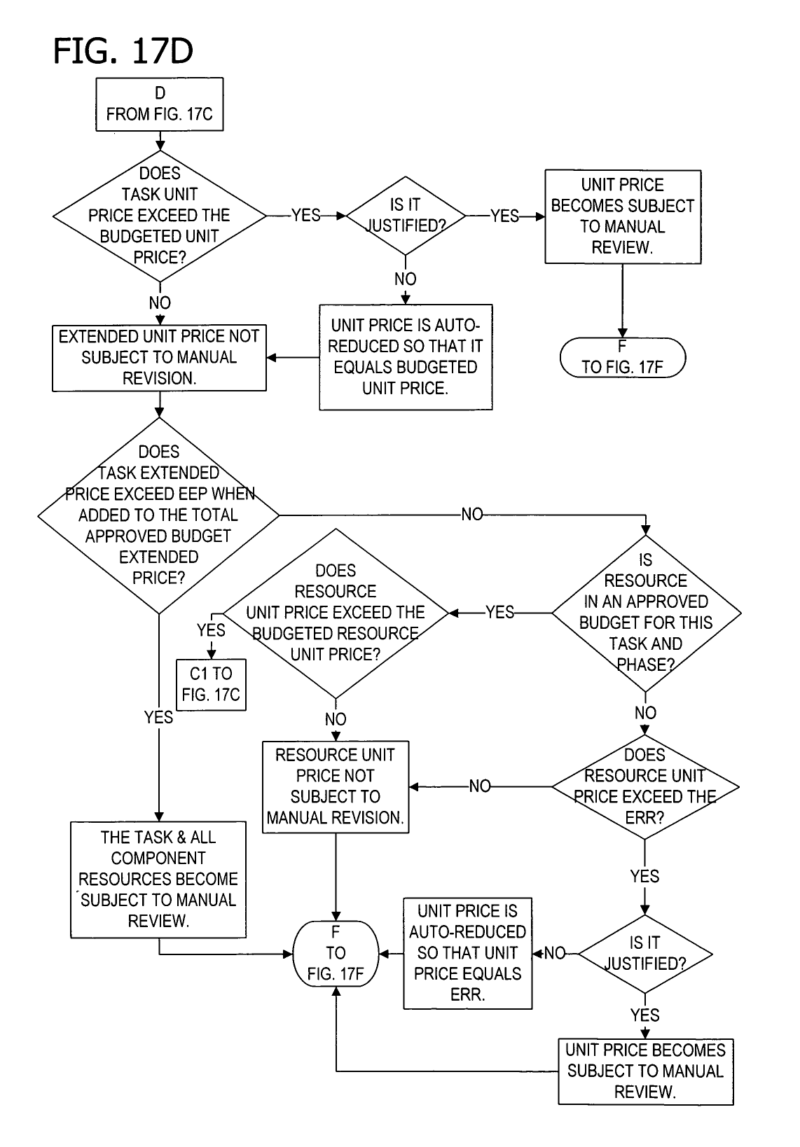

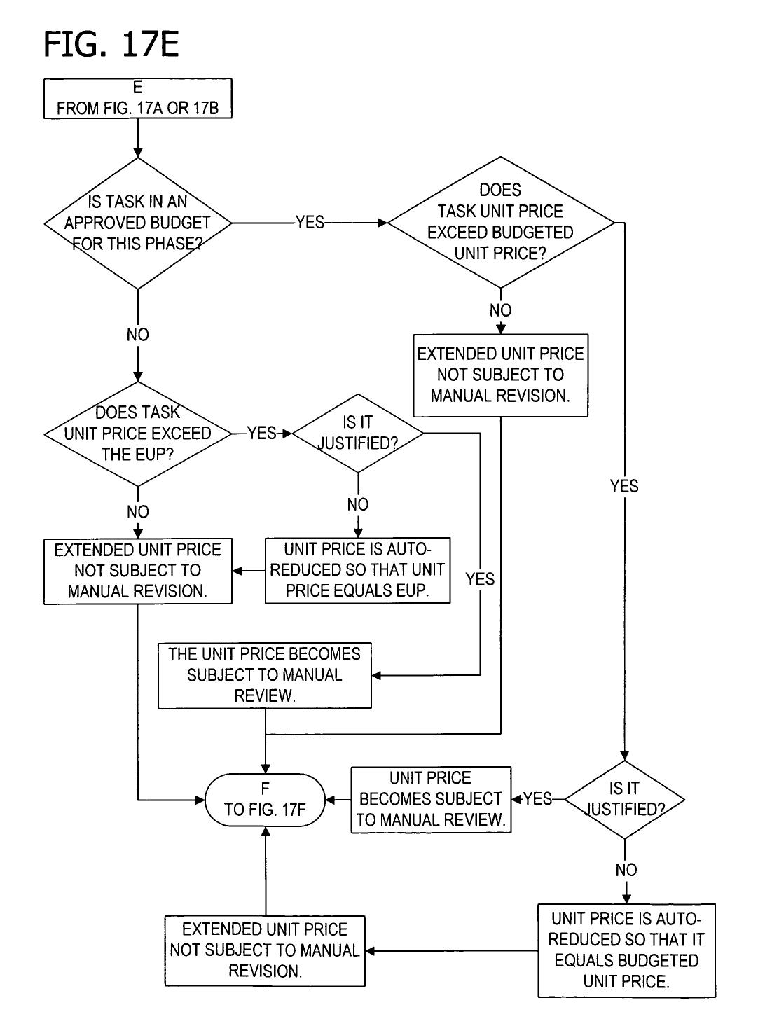

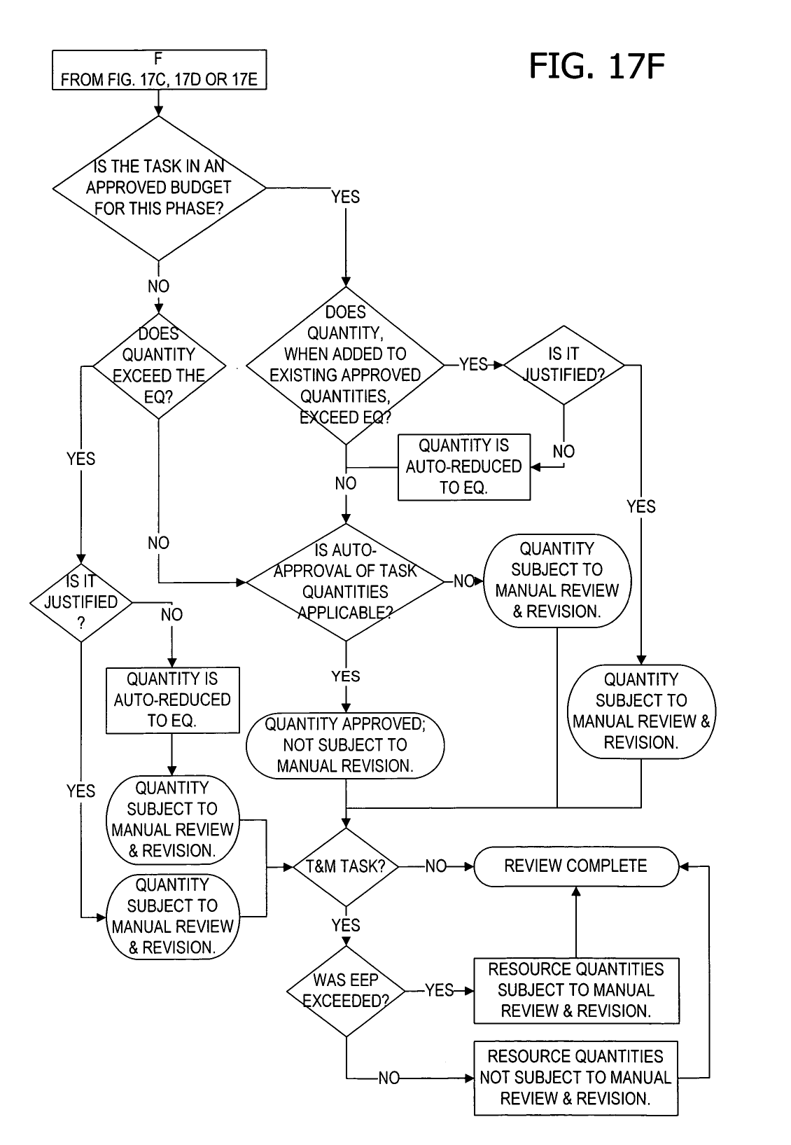

Described below is the budgeted payment application review process as illustrated in FIG. 7B.
a. All payment requests will be time- and date-stamped.
b. The system will also check the rules and phase of the incident. It will know the rules from the regulatory authority table containing the incident numbers. It will know the phase from the document. It will decide based on this whether or not to use the budgeted payment application screens and routines or the non-budgetable payment application review screens and routines.
c. Immediately upon receipt and validation of a payment application from the web-based interface at 500, the system will run routines at 502, 504 to search for non-budgeted pricing, tasks, resources, billing methods and UOMs. Please refer to FIGS. 17A through 17F. These routines are done upon receipt and not later in time because in the case of any non-budgeted tasks or resources, it is the rules and rates in effect at time of receipt that govern budget submittals. The following are validation functions carried out on payment applications for work requiring an approved budget:
   Non-Standard Task: if the proposed task is not present in a previously approved budget for this phase (or, for a task which is newly proposed for that phase, not present in the WBS) and is not justified by the consultant, the system will auto-reject the task; if it is justified, the task will be subject to detailed manual review.
   Non-Standard Task Billing Method: If the proposed task billing method is for a task that has never previously been budgeted for this phase, it will be handled as described above for Non-Standard Tasks. If the proposed task billing method is for a budgeted task but differs from the billing method originally approved, it will be auto-rejected.
   Non-Standard Task Unit of Measure: If the proposed task unit of measure is for a task that has never previously been budgeted for this phase, it will be handled as described above for Non-Standard Tasks. If the proposed task unit of measure is for a budgeted task but differs from the unit of measure originally approved, it will be auto-rejected.
   Non-Standard Resource: if the proposed resource is not present in a previously approved budget for this phase (or, for a resource which is newly proposed for that phase, not present in the SRS) and is not justified by the consultant, the system will auto-reject the task; if it is justified, the task will be subject to detailed manual review.
   Non-Standard Resource Billing Method: If the proposed resource billing method is for a resource that has never previously been budgeted for this phase, it will be handled as described above for Non-Standard Resources. If the proposed resource billing method is for a budgeted resource but differs from the billing method originally approved, it will be auto-rejected.
   Non-Standard Resource Unit of Measure: If the proposed resource unit of measure is for a resource that has never previously been budgeted for this phase, it will be handled as described above for Non-Standard Resources. If the proposed resource unit of measure is for a budgeted resource but differs from the unit of measure originally approved, it will be auto-rejected.
   Expedited Unit Price Exceedence: if the proposed task unit price exceeds a previously approved budgeted unit price (or, for a task which is newly proposed for this phase, exceeds the Expedited Unit Price or “EUP”), and is not justified, the unit price will be auto-reduced by the system to a level to a level equaling the previously budgeted unit price or EUP. If the task is justified, then the task unit price is subject to manual review.
   Expedited Unit Price Compliance: if the proposed task unit price is less than or equal to the previously approved budgeted unit price (or, for a task which is newly proposed for this phase, less than or equal to the Expedited Unit Price or “EUP”), the unit price will be approved as proposed by the system and it will not be subject to manual review.
   Expedited Extended Price Exceedence (time and materials tasks only): if the proposed task extended (total) price exceeds a previously approved budgeted extended price (or, for a task which is newly proposed for this phase, exceeds the Expedited Extended Price or “EEP” when added to any existing approved extended task price), the task will be subject that task to line-item manual review of all resources in that task.
   Expedited Extended Price Compliance (time and materials tasks only): if the proposed task extended (total) price is less than or equal to a previously approved budgeted extended price (or, for a task which is newly proposed for this phase, is less than or equal to the Expedited Extended Price or “EEP”), the task will not be subject to line-item manual review of all resources in that task (provided that the resource unit prices are in compliance and, in one embodiment, none are marked for handling charges).
   Expedited Resource Rate Exceedence: if the proposed resource unit price exceeds a previously approved budgeted unit price (or, for a resource which is newly proposed for this phase, exceeds the Expedited Resource Rate or “ERR”), and is not justified, the unit price will be auto-reduced by the system to a level to a level equaling the previously budgeted unit price or ERR. If the resource is justified, then the task unit price is subject to manual review.
   Expedited Resource Rate Compliance: if the proposed resource unit price is less than or equal to the previously approved budgeted unit price (or, for a task which is newly proposed for this phase, less than or equal to the Expedited Resource Rate or “ERR”), the unit price will be approved as proposed by the system and it will not be subject to manual review.
   Expedited Quantity Exceedence: if the proposed task quantity, when added to any existing approved quantities for the incident and phase, exceeds the budgeted quantity for that task (or, for a task which is newly proposed for this phase, exceeds the Expedited Quantity or EQ), and it is not justified, the system will auto-reduce the quantity to a level at which the total approved quantity will equal the EQ. If the task is justified, then the task quantity is subject to manual review.
   Expedited Quantity Compliance: if the proposed task quantity, when added to any existing approved quantities for the incident and phase, is less than or equal to the budgeted quantity for that task (or, for a task which is newly proposed for this phase, is less than or equal to the Expedited Quantity or EQ), the system may, at the regulatory authority's discretion, auto-approve the quantity at 506. Otherwise, the task quantity is subject to manual review.
   Non-Budgeted Handling Charges: in one embodiment, if a task or resource item is marked as being eligible for the application of a handling charge, but the corresponding task or resource in the budget is not marked as being eligible for handling, and the task or resource is not marked justified, the system will auto-reject the application of a handling charge to that item. If it is marked as justified, the application of handling will be subject to manual review.
d. If a payment application for a budgeted phase of work uses only budgeted tasks and resources, meets budgeted pricing, and meets budgeted quantities, it may be auto-approved without manual review at 512 if the system administrator has enabled quantity auto-approval and does not require justification of handling charges. If quantity auto-approval is not enabled, it will be subject to a manual technical review at 514. If justification of handling charges is required, it will also be subject to manual accounting review of those charges at 508.

If a budgeted payment application does not meet all budgeted pricing requirements, and/or fails to use budgeted tasks and resources (and in one embodiment, fails to have handling charge items marked for justification), then the budget submittal will be subject to manual accounting review as its first manual review at 508. Following manual accounting review, the budget submittal will be subject to manual technical review at 514 (unless auto-approval of quantities is authorized, and the budget has acceptable quantities proposed, in which case there will not be a manual technical review and the budget submittal will be auto-approved after accounting review) at 512.

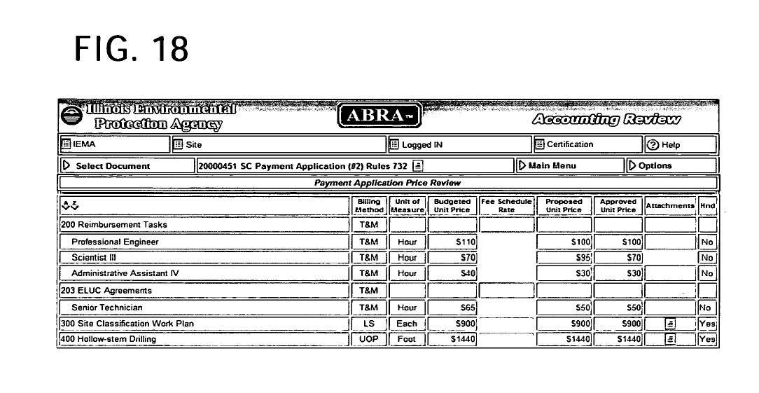

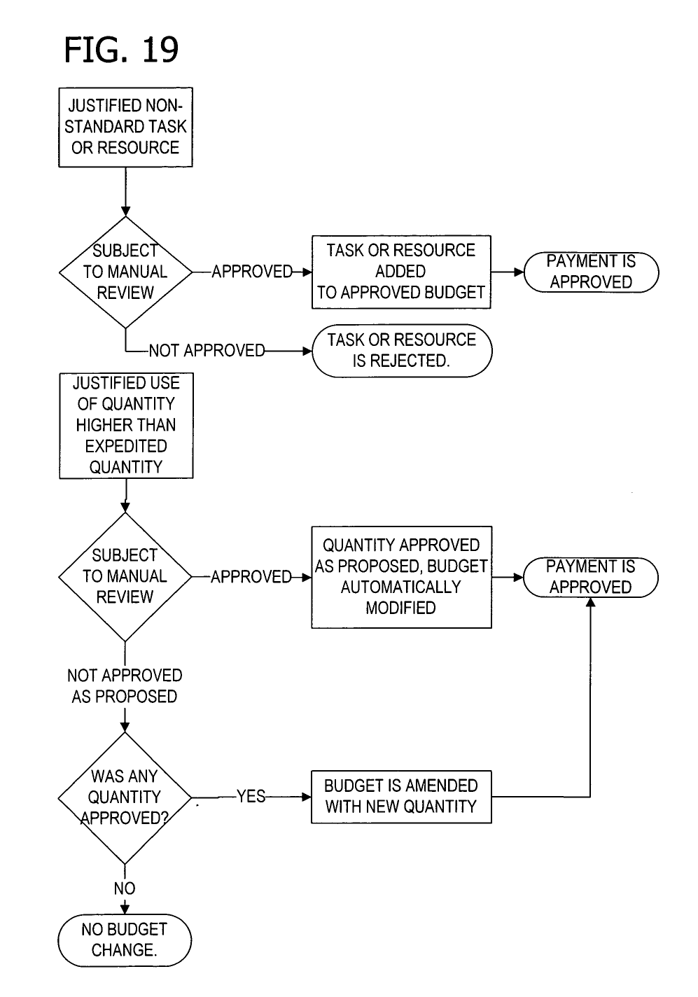

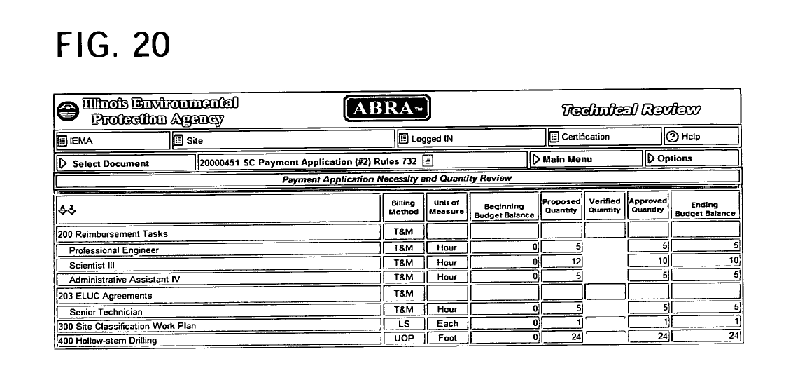

If a payment application for a budgeted phase of work is subject to both accounting manual review and technical manual review, the accounting review at 508 shall be performed first. The payment application will not be available for technical review until the accounting review is completed.
e. Accounting Reviewers will choose payment applications for review from a lookup screen that lists all unreviewed budget proposals and payment applications (FIG. 11).
f. Accounting Reviewers may take the following actions during their manual review at 508 (see FIG. 12). These actions will take place within the Payment Application Accounting Review Screen, FIG. 18:
   Justified Non-Standard Task Billing Method: If the proposed task billing method is for a task that has never been budgeted for this phase, it does not match the billing method specified for that task in the WBS, and it is justified, the task will be subject to reviewer approval or rejection based on the merit of the justification provided.
   Justified Non-Standard Task Unit of Measure: If the proposed task unit of measure is for a task that has never been budgeted for this phase, it does not match the unit of measure specified for that task in the WBS, and it is justified, the task will be subject to reviewer approval or rejection based on the merit of the justification provided.
   Justified Non-Standard Resource Billing Method: If the proposed resource billing method is for a resource that has never been budgeted for this phase, it does not match the billing method specified for that resource in the SRS, and it is justified, the resource will be subject to reviewer approval or rejection based on the merit of the justification provided.
   Justified Non-Standard Resource Unit of Measure: If the proposed resource unit of measure is for a resource that has never been budgeted for this phase, it does not match the unit of measure specified for that resource in the SRS, and it is justified, the resource will be subject to reviewer approval or rejection based on the merit of the justification provided.
   Justified Expedited Unit Price Exceedence: if the proposed task unit price exceeds the Expedited Unit Price (“EUP”) or a previously approved budgeted unit price and it is justified, then the reviewer may accept the unit price as proposed, or reduce it to any level he or she may see fit, except that in no case may the task unit price be lowered to a price below that in the WBS or in a previously approved budget for that same task, incident and phase.
   Justified Expedited Resource Rate Exceedence: if the proposed resource unit price exceeds the Expedited Resource Rate (“ERR”) or a previously approved budgeted unit price and it is justified, then the reviewer may accept the unit price as proposed, or reduce it to any level he or she may see fit, except that in no case may the resource unit price be lowered to a price below that in the SRS or in a previously approved budget for that same resource, incident and phase.
   Justified Handling Charges: in one embodiment, if the item is marked as being eligible for the application of a handling charge and it is marked justified, the Accounting Reviewer may approve or deny the application of a handling charge to that item based on their review of the justification for same.
g. Once the Accounting Review is complete, the reviewer may mark the payment application as “Confirmed” at 510 This action will make the payment application available to the Technical Reviewer for selection and review. If the Accounting Reviewer chooses not to confirm a payment application at a given time, he or she may save their edits by clicking a “Save Changes/Hold for Further Review” button. In one embodiment of this invention, doing this will trigger an email to the Consultant notifying them that the payment application has been placed on hold. This will enable them, in the event the regulatory authority doesn't contact them first, to follow up with the regulatory authority to see what the problem is.
h. Technical Reviewers will choose payment applications for review from a lookup screen that lists all unreviewed payment applications (FIG. 14). As stated above, payment applications are not available for technical review until they pass accounting review, if one is required.
i. Technical Reviewers may take the following actions during their manual review at 514 (see FIG. 19). These actions will be performed from within the Payment Application Technical Review Screen, FIG. 20:
   Justified Non-Standard Task: If the proposed task is not present in the approved budget for this phase but it is justified, the task will be subject to approval or denial of its use, based on the technical judgment of its necessity by the technical reviewer.
   Justified Non-Standard Resource: if the proposed resource is not present in the approved budget for this phase but it is justified, the resource will be subject to approval or denial of its use, based on the technical judgment of its necessity by the technical reviewer.
   Justified Expedited Quantity Exceedence: if the proposed task quantity, when added to any existing approved quantities for the incident and phase, exceeds the Expedited Quantity (“EQ”), but it is justified, the reviewer may accept the quantity as proposed, or reduce it to any level he or she may see fit, except that in no case may the resource unit price be lowered to a quantity which, when added to any previously approved quantities for this task, incident and phase, will be below the EQ. In another embodiment of this invention, the reviewer will record both a quantity performed and a quantity approved. The distinction may be necessary because while a given quantity of work may be performed, and should be recorded, that is not the necessarily the quantity of work that is deemed to be necessary and approvable for payment.
j. When any manual modification or rejection of a payment application item is made by either an accounting or a technical reviewer, the reviewer is required to enter a justification for taking that action. The payment application review cannot be confirmed until all such changes are accompanied by reviewer justification.
k. Handling charges will not be displayed, as they are solely a function of which, if any, resources are marked as eligible for handling by the certifying professional. Application of handling charges is done by the system, not by the consultant or by the Regulatory Authority.
l. If the Technical Reviewer chooses not to confirm a payment application at a given time, he or she may save their edits by clicking a “Save Changes/Hold for Further Review” button. In one embodiment of this invention, doing this will trigger an email to the Consultant notifying them that the payment application has been placed on hold. This will enable them, in the event the regulatory authority doesn't contact them first, to follow up with the regulatory authority to see what the problem is.
m. Once the final review is complete (Accounting and/or Technical, as the case may be), the reviewer will confirm the payment application at 516. Quantities approved will be updated and changes in task and resource characteristics will be recorded at 518. The original payment application record will still be in the database in its original form, so reporting and analysis may be performed on the basis of proposed versus approved record(s). A record is created even if every component of a payment application is rejected.
n. A payment application may also be marked as “withdrawn” during either Accounting or Technical review if the consultant asks that it no longer be considered. The records is still retained but is flagged as “withdrawn.” Withdrawn payment applications may, at the regulatory administrator's option, be excluded from statistical analyses and reporting.
o. A unique feature of this system is that if any reviewer approves a quantity, a unit price, or even an entirely new task or resource than was originally budgeted, the system will automatically create a budget amendment to that effect to apply the changes to the budget on a going-forward basis. For example, approval of a quantity in excess of the remaining budget balance will automatically amend the budget by that quantity so the approved payment application does not cause a negative quantity balance. In the case of pricing, an acknowledgement by the reviewer that a different unit price than was originally budgeted is in fact appropriate causes the system to apply that pricing change to that item for the remainder of the phase.
   12. Payment Application Review for Work that Doesn't Require an Approved Budget

This process is very similar, but not identical, to that for the review of budget proposals.

This system enables a two-tiered regulatory review approach. The first tier illustrated in FIG. 9B is a financial review of the unit prices associated with the tasks and resources proposed for payment. The second tier illustrated in FIG. 9B is a technical review of the technical merits of the tasks and resources proposed for payment, and the quantities of each. It is important to note the following key points about non-budgetable payment application review:
Accounting reviewers do not see any quantity or extended price data.
Technical review is limited to only the confirmation that work for which payment is requested was necessary, was actually performed in the quantities indicated, and that the quantities indicated were reasonable and necessary.
Technical reviewers do not see any unit or extended price data.

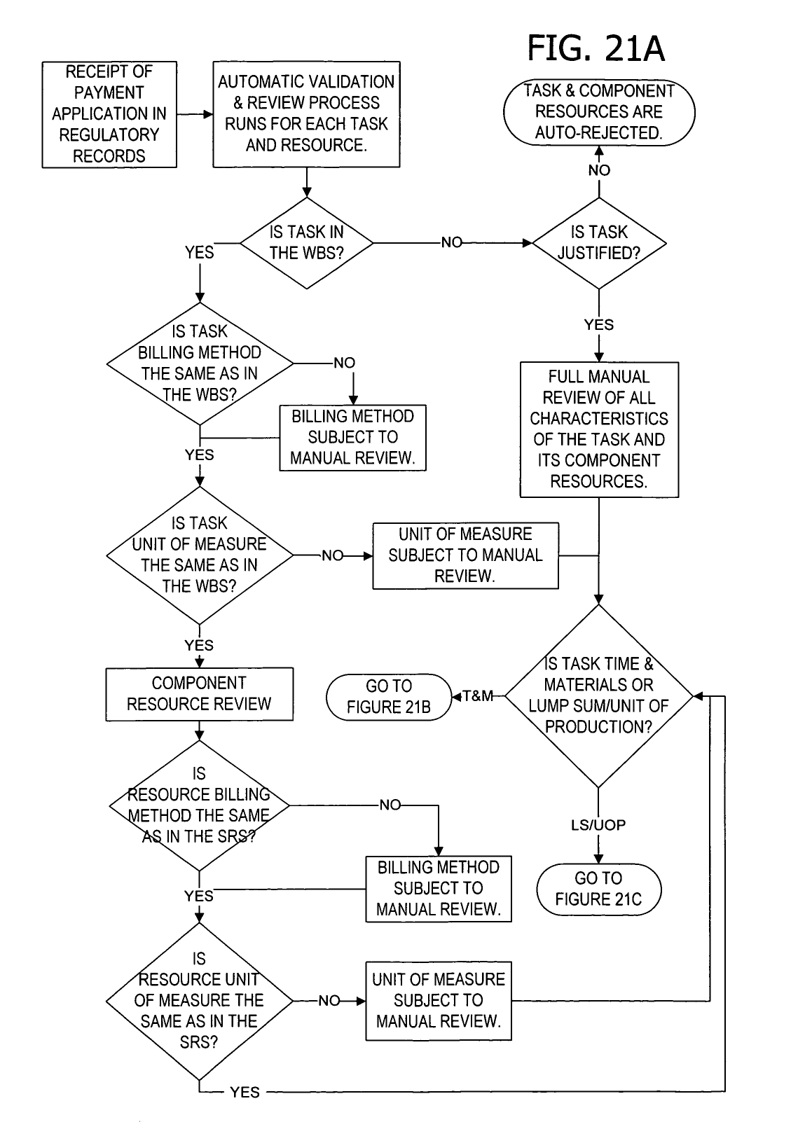

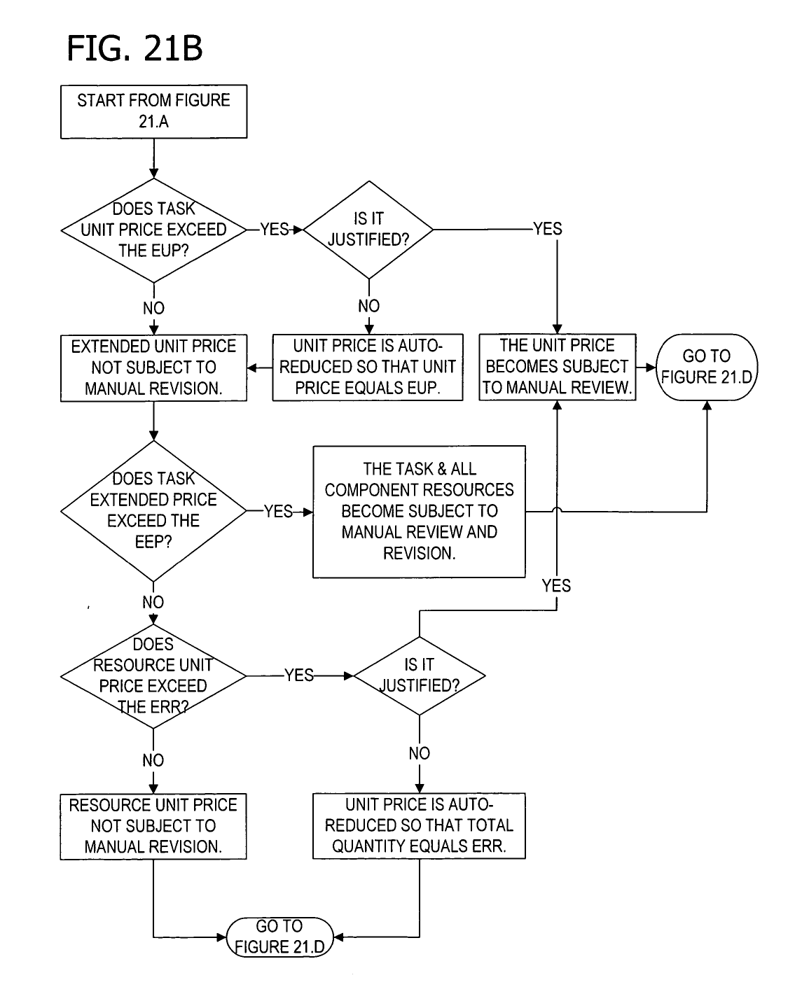

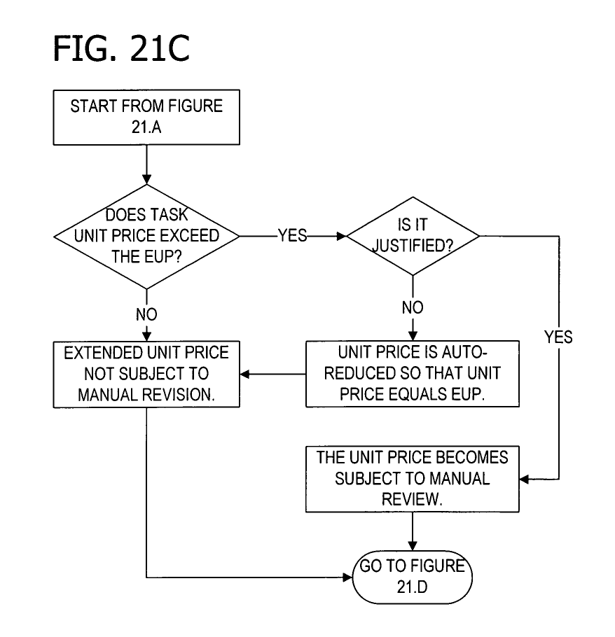

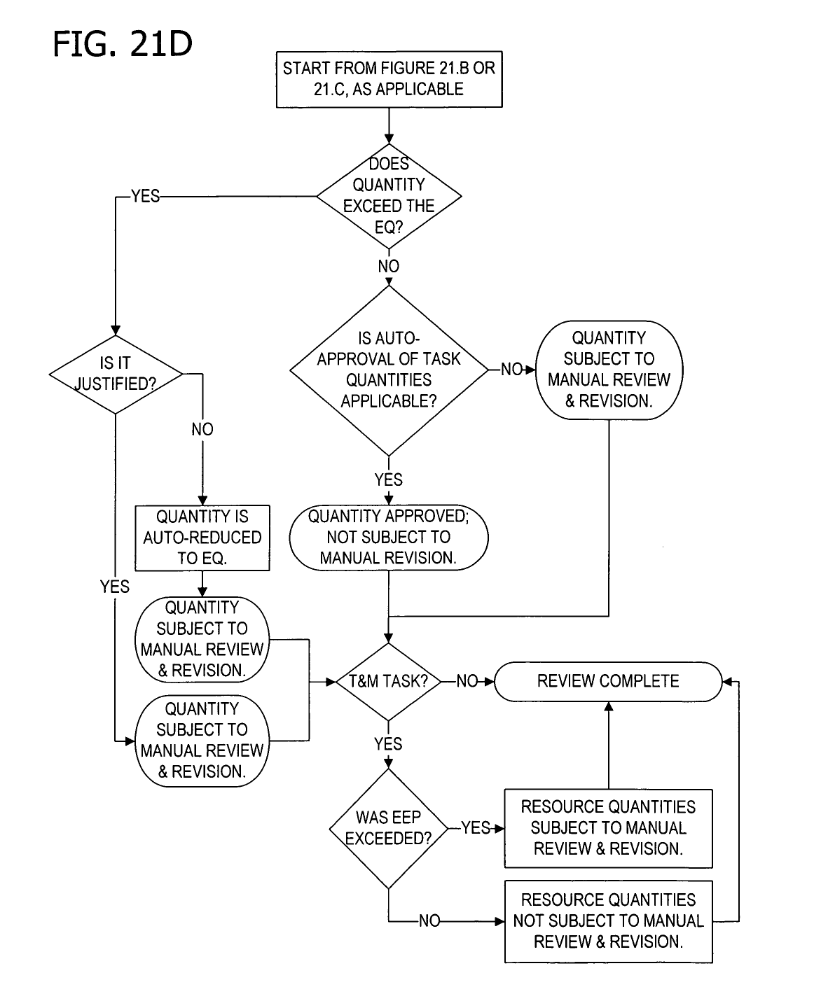

Described below is the non-budgetable payment application review process illustrated in FIG. 9b.
a. All non-budgetable payment applications will be time- and date-stamped.
b. The system will check the rules and phase of the incident. It will know the rules from the regulatory authority table containing the incident numbers. It will know the phase from the document. It will decide based on this whether or not to use the budgeted payment application screens and routines or the non-budgetable payment application review screens and routines.
c. Immediately upon receipt and validation of a non-budgetable payment application from the web-based interface at 600, the system will run routines at 602 to search for non-standard pricing, tasks, resources, billing methods and UOMs. Please refer to FIGS. 21A through 21D. These routines are done upon receipt and not later in time because it is the rules and rates in effect at time of receipt that rule non-budgetable payment applications. The following are validation functions carried out on payment applications for work requiring an approved budget:
   Non-Standard Task: if the proposed task is not present in the WBS and is not justified by the consultant, the system will auto-reject the task and it will not be visible to the reviewer. If it is justified, the task will be subject to detailed manual review.
   Non-Standard Task Billing Method: If the proposed task billing method does not match the billing method specified for that task in the WBS, the system will auto-reject the task if it is not justified and it will not be visible to the reviewer. If it is justified, the task will be subject to detailed manual review.
   Non-Standard Task Unit of Measure: If the proposed task unit of measure does not match the unit of measure specified for that task in the WBS, the system will auto-reject the task if it is not justified and it will not be visible to the reviewer. If it is justified, the task will be subject to detailed manual review.
   Non-Standard Resource: if the proposed resource is not present in the SRS and is not justified by the consultant, the system will auto-reject the task and it will not be visible to the reviewer. If it is justified, the task will be subject to detailed manual review.
   Non-Standard Resource Billing Method: If the proposed resource billing method does not match the billing method specified for that resource in the SRS, the system will auto-reject the resource if it is not justified and it will not be visible to the reviewer. If it is justified, the resource will be subject to detailed manual review.
   Non-Standard Resource Unit of Measure: If the proposed resource unit of measure does not match the unit of measure specified for that resource in the SRS, the system will auto-reject the resource if it is not justified and it will not be visible to the reviewer. If it is justified, the resource will be subject to detailed manual review.
   Expedited Unit Price Exceedence: if the proposed task unit price exceeds the Expedited Unit Price (“EUP”) and is not justified, the unit price will be auto-reduced by the system to a level to a level equaling the EUP. If the task is justified, then the task unit price is subject to manual review.
   Expedited Unit Price Compliance: if the proposed task unit price is less than or equal to the Expedited Unit Price (“EUP”), the unit price will be approved as proposed by the system and it will not be subject to manual review.
   Expedited Extended Price Exceedence (time and materials tasks only): if the proposed task extended (total) price exceeds the Expedited Extended Price (“EEP”), or when added to any previously approved (for payment purposes) extended task prices, the total will exceed the EEP, the task will be subject that task to line-item manual review of all resources in that task.
   Expedited Extended Price Compliance (time and materials tasks only): if the proposed task extended (total) price is less than or equal to the Expedited Extended Price (“EEP”), the task will not be subject to line-item manual review of all resources in that task (provided that the resource unit prices are in compliance and, in one embodiment, none are marked for handling charges)
   Expedited Resource Rate Exceedence: if the proposed resource unit price exceeds the Expedited Resource Rate (“ERR”) and is not justified, the unit price will be auto-reduced by the system to a level to a level equaling the ERR. If the task is justified, then the resource unit price is subject to manual review.
   Expedited Resource Rate Compliance: if the proposed resource unit price is less than or equal to the Expedited Resource Rate (“ERR”), the unit price will be approved as proposed by the system and it will not be subject to manual review.
   Expedited Quantity Exceedence: if the proposed task quantity, when added to any previously approved quantities for the incident and phase, exceeds the Expedited Quantity (“EQ”), and it is not justified, the system will auto-reduce the quantity to a level at which the total approved quantity will equal the EQ. If the task is justified, then the task quantity is subject to manual review.
   Expedited Quantity Compliance: if the proposed task quantity, when added to any previously approved quantities for the incident and phase, is less than or equal to the Expedited Quantity (“EQ”), the system may, at the regulatory authority's discretion, auto-approve the quantity at 604 (see Section II.B.13, Auto-review and Approval of Quantities). Otherwise, the task quantity is subject to manual review.
   Handling Charges: in one embodiment, if a task or resource is marked as being eligible for the application of a handling charge, but the consultant failed to mark that item as justified, the system will auto-reject the application of a handling charge to that item. If it is marked as justified, the application of handling will be subject to manual review.
d. If a non-budgetable payment application uses only standard tasks and resources, meets expedited pricing, and meets expedited quantities, it may be auto-approved without manual review at 610 if the system administrator has enabled quantity auto-approval and does not require justification of handling charges. If quantity auto-approval is not enabled, it will be subject to a manual technical review at 612. If justification of handling charges is required, it will also be subject to manual accounting review of those charges at 606.

If a nonbudgetable payment application does not meet all expedited pricing requirements, and/or fails to use completely standard tasks and resources (and in one embodiment, fails to have handling charge items marked for justification), then the nonbudgetable payment application will be subject to manual accounting review as its first manual review at 606. Following manual accounting review, the nonbudgetable payment application will be subject to manual technical review at 612 (unless auto-approval of quantities is authorized, and the nonbudgetable payment application has acceptable quantities proposed, in which case there will not be a manual technical review and the nonbudgetable payment application will be auto-approved after accounting review) at 610.

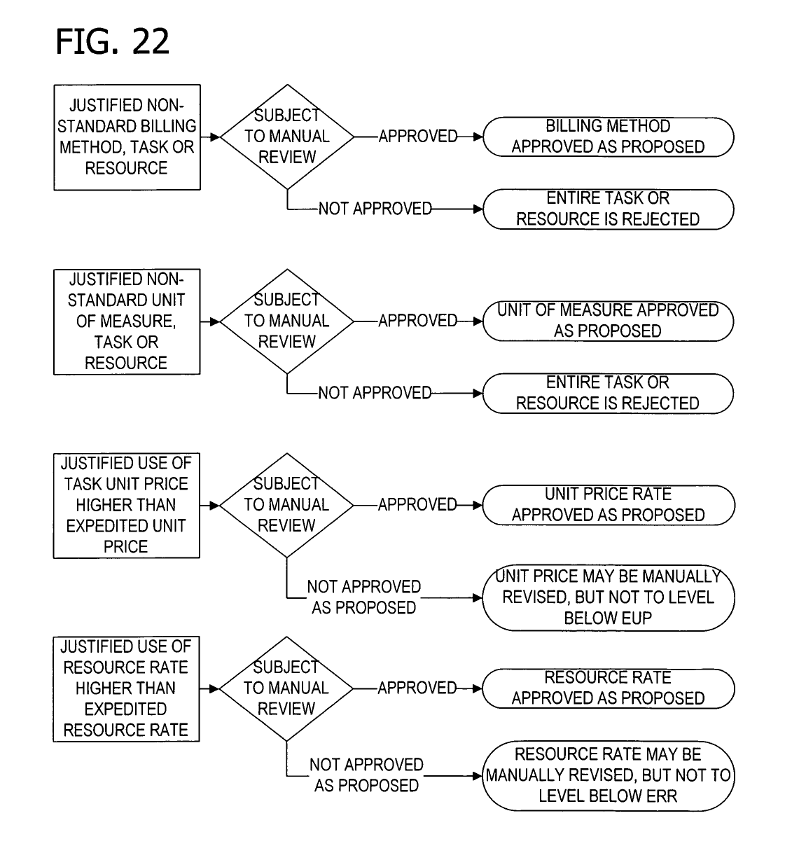

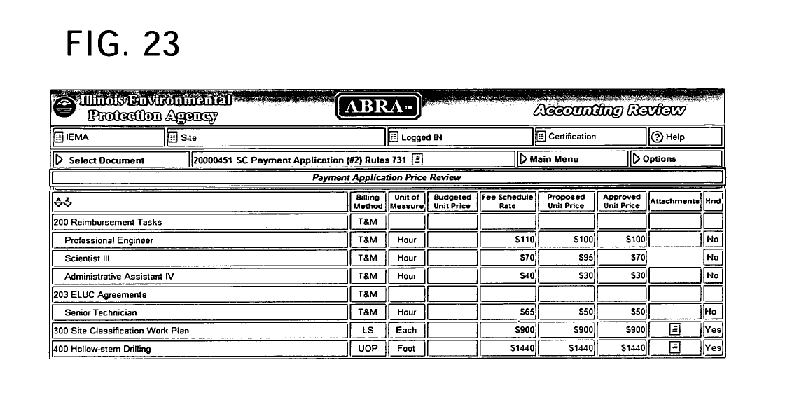

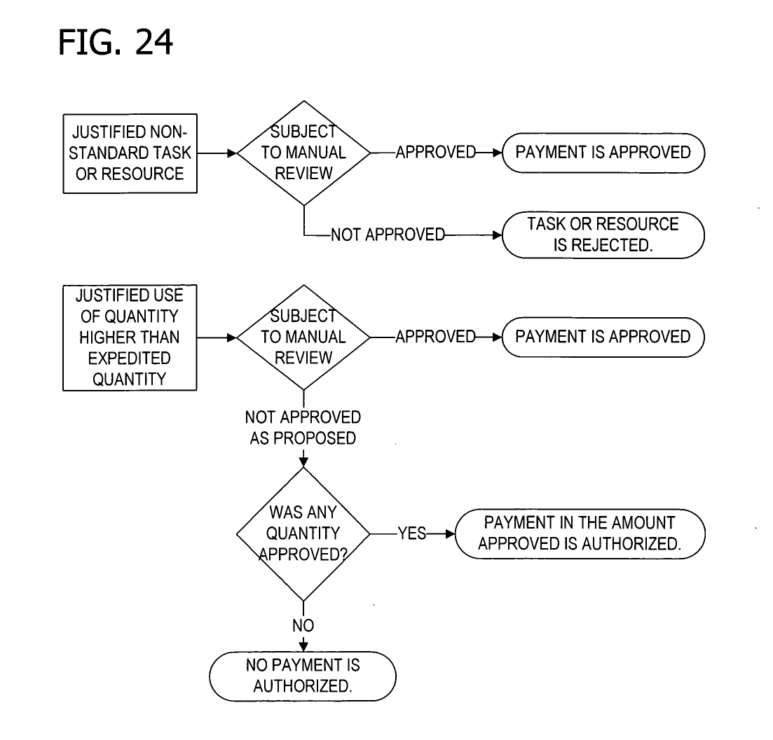

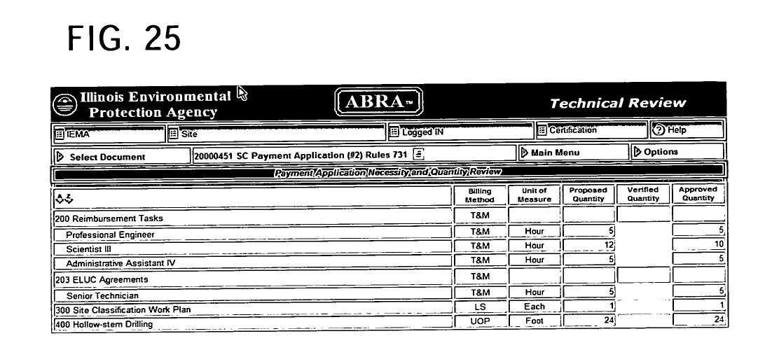

If a nonbudgetable payment application is subject to both accounting manual review and technical manual review, the accounting review at 606 shall be performed first. The nonbudgetable payment application will not be available for technical review until the accounting review is completed.
e. Accounting Reviewers will choose nonbudgetable payment applications for review from a lookup screen that lists all unreviewed budget proposals and payment applications (FIG. 11).
f. Accounting Reviewers may take the following actions during their manual review at 606 (see FIG. 22). These actions will be performed from within the Nonbudgetable Payment Application Accounting Review Screen, FIG. 23:
   Justified Non-Standard Task Billing Method: If the proposed task billing method does not match the billing method specified for that task in the WBS and it is justified, the task will be subject to reviewer approval or rejection based on the merit of the justification provided.
   Justified Non-Standard Task Unit of Measure: If the proposed task unit of measure does not match the unit of measure specified for that task in the WBS and it is justified, the task will be subject to reviewer approval or rejection based on the merit of the justification provided.
   Justified Non-Standard Resource Billing Method: If the proposed resource billing method does not match the billing method specified for that resource in the SRS and it is justified, the resource will be subject to reviewer approval or rejection based on the merit of the justification provided.
   Justified Non-Standard Resource Unit of Measure: If the proposed resource unit of measure does not match the unit of measure specified for that resource in the SRS and it is justified, the resource will be subject to reviewer approval or rejection based on the merit of the justification provided.
   Justified Expedited Unit Price Exceedence: if the proposed task unit price exceeds the Expedited Unit Price (“EUP”) and it is justified, then the reviewer may accept the unit price as proposed, or reduce it to any level he or she may see fit, except that in no case may the task unit price be lowered to a price below that in the WBS.
   Justified Expedited Resource Rate Exceedence: if the proposed resource unit price exceeds the Expedited Resource Rate (“ERR”) and it is justified, then the reviewer may accept the unit price as proposed, or reduce it to any level he or she may see fit, except that in no case may the resource unit price be lowered to a price below that in the SRS.
   Justified Handling Charges: in one embodiment, if the item is marked as being eligible for the application of a handling charge and it is marked justified, the Accounting Reviewer may approve or deny the application of a handling charge to that item based on their review of the justification for same.
g. Once the Accounting Review is complete, the reviewer may mark the nonbudgetable payment application as “Confirmed” at 608. This action will make the nonbudgetable payment application available to the Technical Reviewer for selection and review. If the Accounting Reviewer chooses not to confirm a nonbudgetable payment application at a given time, he or she may save their edits by clicking a “Save Changes/Hold for Further Review” button. In one embodiment of this invention, doing this will trigger an email to the Consultant notifying them that the nonbudgetable payment application has been placed on hold. This will enable them, in the event the regulatory authority doesn't contact them first, to follow up with the regulatory authority to see what the problem is.
h. Technical Reviewers will choose nonbudgetable payment applications for review from a lookup screen that lists all unreviewed nonbudgetable payment applications (FIG. 14). As stated above, nonbudgetable payment applications are not available for technical review until they pass accounting review, if one is required.
i. Technical Reviewers may take the following actions during their manual review at 612 (see FIG. 24). These actions will be performed from within the Payment Application Technical Review Screen, FIG. 25:
   Justified Non-Standard Task: If the proposed task is not present in the WBS and it is justified, the task will be subject to approval or denial of its use, based on the technical judgment of its necessity by the technical reviewer.
   Justified Non-Standard Resource: if the proposed resource is not present in the SRS and is not justified by the consultant, the system will auto-reject the task and it will not be visible to the reviewer. If it is justified, the resource will be subject to approval or denial of its use, based on the technical judgment of its necessity by the technical reviewer.
   Justified Expedited Quantity Exceedence: if the proposed task quantity, when added to any existing approved quantities for the incident and phase, exceeds the Expedited Quantity (“EQ”), but it is justified, the reviewer may accept the quantity as proposed, or reduce it to any level he or she may see fit, except that in no case may the resource unit price be lowered to a quantity which, when added to any previously approved quantities for this task, incident and phase, will be below the EQ. In another embodiment of this invention, the reviewer will record both a quantity performed and a quantity approved. The distinction may be necessary because while a given quantity of work may be performed, and should be recorded, that is not the necessarily the quantity of work that is deemed to be necessary and approvable for payment.
j. If the Technical Reviewer chooses not to confirm a nonbudgetable payment application at a given time, he or she may save their edits by clicking a “Save Changes/Hold for Further Review” button. In one embodiment of this invention, doing this will trigger an email to the Consultant notifying them that the nonbudgetable payment application has been placed on hold. This will enable them, in the event the regulatory authority doesn't contact them first, to follow up with the regulatory authority to see what the problem is.
k. Handling charges will not be displayed, as they are solely a function of which, if any, resources are marked as eligible for handling by the certifying professional. Application of handling charges is done by the system, not by the consultant or by the regulatory authority.
l. When any manual modification or rejection of a nonbudgetable payment application item is made by either an accounting or a technical reviewer, the reviewer is required to enter a justification for taking that action. The nonbudgetable payment application review cannot be confirmed until all such changes are accompanied by reviewer justification.
m. Once the final review is complete (Accounting and/or Technical, as the case may be), the reviewer will confirm the nonbudgetable payment application at 614. Quantities approved will be updated and changes in task and resource characteristics will be recorded at 616. The original nonbudgetable payment application record will still be in the database in its original form, so reporting and analysis may be performed on the basis of proposed versus approved record(s). A record is created even if every component of a nonbudgetable payment application is rejected.
n. A non-budgetable payment application may also be marked as “withdrawn” during either Accounting or Technical review if the consultant asks that it no longer be considered. The records is still retained but is flagged as “withdrawn.” Withdrawn payment applications may, at the regulatory administrator's option, be excluded from statistical analyses and reporting.
   13. Auto-Review and Approval of Quantities

In one embodiment, this invention includes a feature which will allow the system to automatically approve proposed quantities, if those quantities are less than or equal to the standard against which they are normally evaluated, for any percentage of budget proposals and payment applications. In the case of budget proposals and nonbudgetable payment applications, that standard would be the EQ for that task; in the case of budgeted payment applications, that standard would be the remaining budget quantity for the task in question.

14. Automated Budget Proposal Review and Payment Application Letters

Once a budget proposal or payment application has been auto-approved and/or confirmed by both the technical and accounting reviewer, all the necessary data is available (including reviewer comments as to why changes were required) to generate an automatic email notification of the regulatory authority's decision to all concerned parties.

15. Budget Proposal and Payment Application Appeals Administration

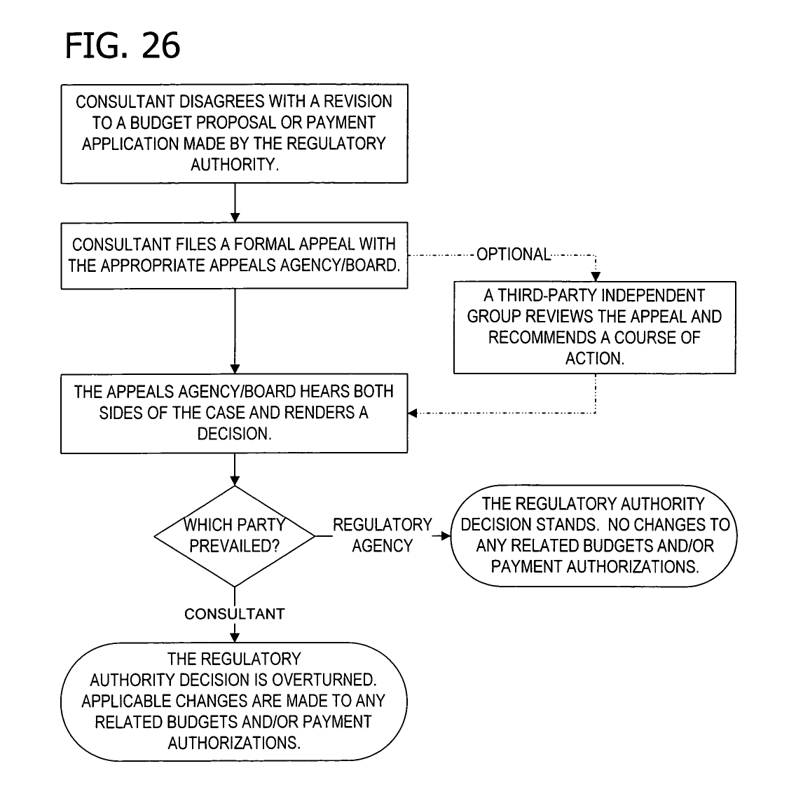

Many regulatory agencies have an appeals process whereby consultants may appeal any manual reviewer action taken on a budget proposal or payment application. Regulatory appeals processes typically involve the referral of the dispute to a government or industry organization for binding resolution. In some cases, there is an intermediate step wherein an independent body may render an initial decision or recommendation before the matter is sent to the final organization for final resolution. Please see FIG. 26 for an overview of the general appeals process.

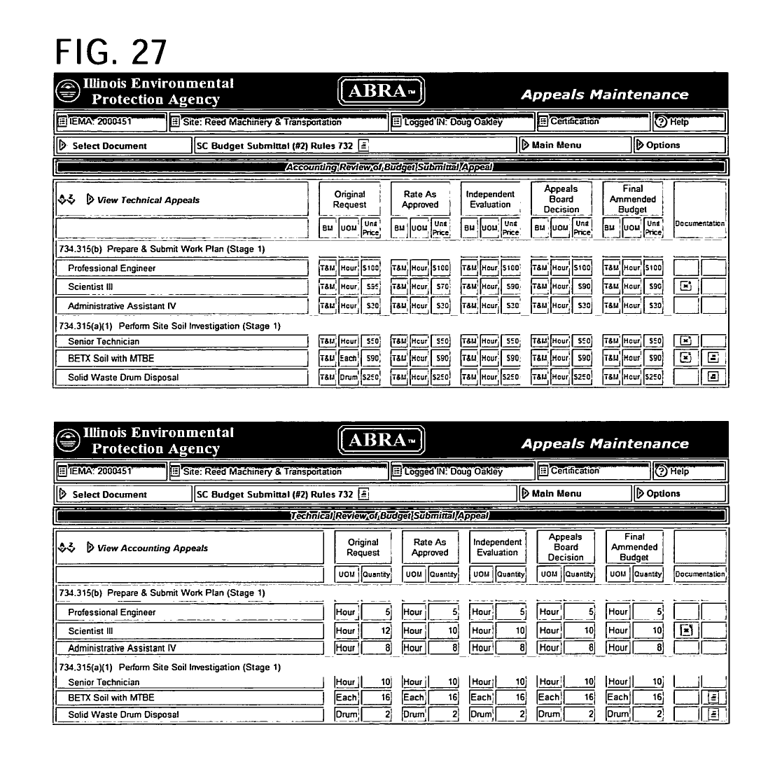

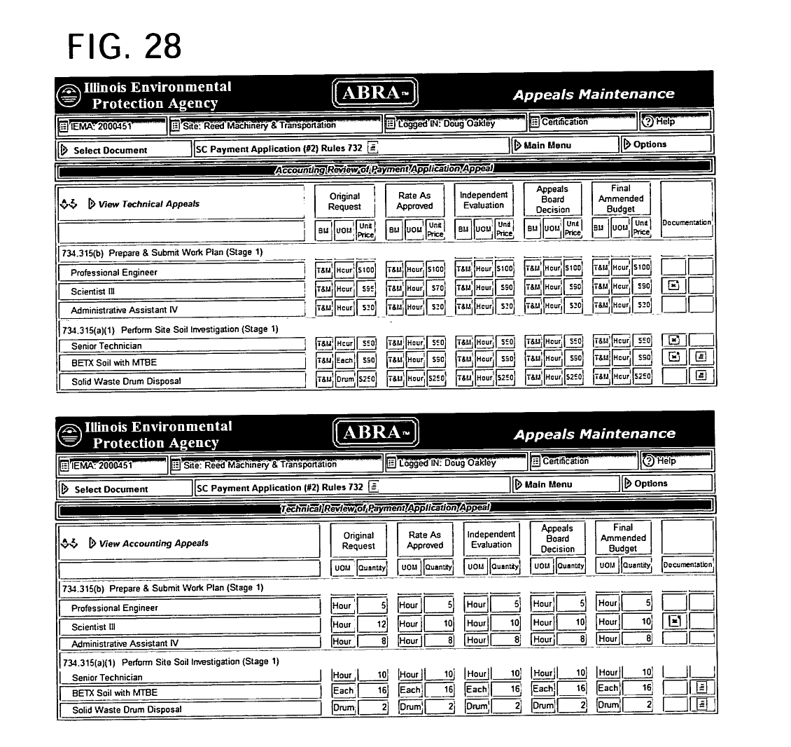

One embodiment of this system can accommodate an appeals process. If an appeal results in a decision which effectively revises the characteristics of an approved budget or payment application, its quantities and/or pricing, the recording of that appeal in the system will create automatic revisions to the budget and/or payment application records (in the same way that approvals of characteristics in conflict with originally approved budgets will create automated budget amendments; see Section II.B.11.o. Please refer to FIG. 27 for the screen design for budget proposal appeals documentation and to FIG. 28 for the screen design for payment application appeals documentation.

16. Statistical Reporting and Analysis

Over time, this database will build a data history that can be used for statistical reporting and analysis. Some of the key data that will be used to perform the following improvements to the system includes the following:
Setting and adjusting appropriate expedited unit pricing for LS and UOP tasks
Setting and adjusting appropriate expedited extended pricing for T&M tasks
Setting and adjusting appropriate expedited resource rates for resources
Setting and adjusting appropriate expedited quantities for LS and UOP tasks
Selecting the most appropriate billing method for tasks
Selecting the most appropriate unit of measure for tasks and resources
Adopting recurring approved non-standard tasks as standard tasks
Adopting recurring approved non-standard resources as standard resources

Some of the key data that will populate the database includes:
Original budget proposal submissions
Final records of automated and manual review actions (which may be approvals of the originals,
modifications thereof, or complete rejections); will include reviewer-entered justifications of any manual modifications or rejections
Automated budget amendments caused by approval of non-budgeted items in payment applications
Third-party recommendations for resolution of appealed budget responses; will include rationale for such recommendations
Automated appeals board budget amendments; will include rationale for decisions
Original payment applications (both budgetable and nonbudgetable)
Final records of automated and manual review actions (which may be approvals of the originals, modifications thereof, or complete rejections); will include reviewer justifications of any modifications or rejections
Automated budget amendments caused by approval of non-budgeted items and/or budgeted items with different characteristics in payment applications
Third-party recommendations for resolution of appealed payment application responses; will include rationale for such recommendations
Automated appeals board payment application amendments; will include rationale for decisions

Data that will be available to authorized users via reporting and/or automated queries includes, but is not limited to:
Total and historical review of budget submissions
Total and historical review of approved budgets
Total and historical review of budget amendments
Total and historical review of budget balance remaining
Total and historical review of applications made for payment
Total and historical review of approved payment applications
Total and historical review of amended payment applications
Frequency of task and resource usage
Average task and resource pricing: by budget and/or payment application; requested, approved, rejected, and/or amended
Type and Frequency of task and/or resource non-standard unit pricing by budget and/or payment application; requested, approved, rejected and/or amended
Type and Frequency of task non-standard billing methods and/or UOMs by budget and/or payment application; requested, approved, rejected, and/or amended
Type and Frequency of resource non-standard UOMs by budget and/or payment application; requested, approved, rejected, and/or amended
Type and Frequency of non-standard task and/or resource usage by budget and/or payment application; requested, approved, rejected and/or amended

Additional reporting will be available that will apply statistically valid analysis to trends in average pricing and the incidence of non-standard items to indicate when changes should be made in the standards. Once the statistical model for recognizing and instituting such changes is agreed upon, a setting in the software could allow such changes to take place automatically. For example, if X percentage of the time, the extended price of a given T&M task falls within a price range of A to B, then the T&M task can be converted to a lump sum task with a price of some value between A and B.

17. Cost Control Incentive

Regulatory agencies that administer cleanup funds have two goals that are somewhat in tension with each other: to drive the cleanup of environmental problems and to minimize the cost to the fund of such work. The only direct means the regulatory agencies have historically had to control costs is to reduce the approved quantity and pricing of such work. This has a chilling and slowing effect on the cleanup of the environment, and all too often places the regulatory authorities in an antagonistic relationship with the consultants doing the work and with the site owners themselves.

The solution is to implement a system of cost control that encourages the market itself to place downward pressure on pricing and quantity. Until now, such a system has never been possible because the necessary data was not collected, analyzed and employed in a way that the market could use and act upon. In one embodiment, this invention is such a system.

The data collected and maintained by this system will enable reporting on the average cost to perform given tasks, by consultant, by specified time period and/or other parameters. This will enable agency administrators to identify what firms are performing specific tasks for the least cost to the program. A portion of the cleanup fund could then be paid as a reward to the firms that perform the work for the least cost to the fund. The availability of incentive payments will encourage consultants to implement additional cost savings measures that will further drive down the average cost to perform the work. This in turn will reduce net cleanup funds outlays but still deliver the same benefit to the environment in cleanup work performed. The exact formula for the incentive payments will be up to the regulatory agency and is simply a matter of changing the reporting available from the system. It could conceivably be done on a weighted basis to account also for the volume of work a firm performs (and resultant total cost to the cleanup fund).

18. Cashflow Projection System

By entering a beginning fund balance and projected fund receipts, the system will be able to generate cash projection reporting on a going-forward basis to agency administrators. The system will have all the necessary data to report on actual cash commitments (approved budget balances) and potential cash commitments (unreviewed budget proposals). As payment applications are processed, committed cash is consumed. When a “final” payment application is made, any unused budget balance at that time moves from committed cash to uncommitted cash. Many other more complicated variations on cashflow projection may be made.

19. Automated Payment of Approved Payment Applications

This system can easily deliver validated payment vouchers to any accounts payable system for issuance of payment checks.

20. Automated Billing of Users

This invention will contain billing mechanisms to enable the billing of consultants and site owners who use the system. Relevant payment data will be collected on each of these parties and stored in the database. Payment by credit card will be enabled by recording credit card information in the system and automatically charging those accounts when applicable. Payment amounts and terms will be set up on a party-by-party basis, but the system will permit default settings to be established. The system will further record the number of certifying professionals which perform work on a given consultant's projects over a given period of time, and assess additional charges is that number exceeds some preset limit. The preset limit will also be a consultant-by-consultant value but will have default values available for use.

C. Additional Optional Features

This invention has several different embodiments that might be constructed. Several are described in the text above. Some other embodiments which are foreseen include:

1. Reversal of Reviews

Technical review of budget proposals and payment applications could be done before the Accounting reviews of same, without affecting the content of the reviews. In this event, budget proposals and payment applications would not become available for accounting review until such time as they have been confirmed by a technical reviewer.

2. Review Content Changes

The responsibility for review and approval of non-standard billing methods and units of measure could be transferred from the Accounting reviewer to the Technical reviewer. All related functionality and content would then reside in the Technical Review screen.

3. Addition or Deletion of Billing Methods

Other billing methods could be used in addition to or in place of the three proposed herein.

4. Additional Levels of Price Justification

Additional tiers of unit price review above that of the Expedited Unit Price level could be added to the system. These would represent levels of pricing which require ever-more-stringent levels of justification. The highest level could conceivably act as an absolute ceiling, above which a unit price cannot be approved.

5. Restriction on the Application of Handling Charges

A maintenance routine to identify certain tasks and/or resources to which handling may not be applied could be included with the system. Such an embodiment would have the advantage of preventing the accidental or uninformed submittal of an item to which handling is normally not applicable.

In one embodiment, the invention may be implemented as one or more computer-readable media having computer executable components as noted above. The components are executed by a computing device and would include web-based modules and/or a management module. One web-based module creates and submits proposals, as noted above. Another web-based module receives proposals including tasks, receives payment applications for partially completed tasks of the proposal, receives payment applications for completed tasks of the proposals and reviews and approves received proposals. A management module, which may be web-based, monitors received proposals and responds to received payment applications.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products and methods without departing from the scope of embodiments of the invention, it is intended that all matter contained in the above description and shown in the accompanying drawings shall be interpreted as illustrative and not in a limiting sense.

What is claimed is:

1. A system for managing cost containment within a plurality of projects, said system comprising a processor configured to execute computer-executable instructions to:
define standardized tasks for the projects;
collect real-time, market-wide, multi-provider costs data for the standardized tasks for each project; and
based on the collected data, develop statistically valid, multi-tiered reimbursement/payment price milestones for each project while preserving the competitive dynamics of a free-market based system.

2. The system of claim 1 wherein the standardized tasks as defined by at least one of the following:
minimum quantities (EQ) based on market data;
minimum task unit pricing (EUP) based on market data;
total task pricing (EEP) for eliminating line-item review;
maximum resource unit pricing (ERR) based on market data; and
budget-specific expedited values (BSEV) including new budget proposals and/or payment applications.

3. The system of claim 11 further comprising instructions to define a schedule for each of the standardized tasks, said schedule comprising a work breakdown structure (WBS) based on market data maintained and periodically updated and wherein the collected resource data comprises a standard resource schedule (SRS) based on market data maintained and periodically updated.

4. A system for managing cost containment within a plurality of projects, said system comprising a processor configured to execute computer-executable instructions to:
define standardized tasks for each of the projects;
define a schedule for the standardized tasks;
collect resource data including pricing data for each of the standardized tasks; and
based on the defined schedule and the collected data, develop multi-tiered reimbursement/payment price milestones for each project.

5. The system of claim 4 wherein the standardized tasks as defined by at least one of the following:
minimum quantities (EQ) based on market data;
minimum task unit pricing (EUP) based on market data;
total task pricing (EEP) for eliminating line-item review;
maximum resource unit pricing (ERR) based on market data; and
budget-specific expedited values (BSEV) including new budget proposals and/or payment applications.

6. The system of claim 4 wherein the defined schedule for each of the standardized tasks comprises a work breakdown structure (WBS) based on market data maintained and periodically updated and wherein the collected resource data comprises a standard resource schedule (SRS) based on market data maintained and periodically updated.

7. The system of claim 6 wherein the computer-executable instructions include instructions for providing a link to an industry standard pricing database to provide comparisons of pricing levels for resources within the standardized resource schedule.

8. The system of claim 4 wherein the computer-executable instructions include instructions to define non-standardized tasks to define the schedule and to collect non-standardized task and resource data.

9. The system of claim 4 wherein the computer-executable instructions include instructions for automated review and approval of proposed quantities of the tasks and instructions to set, at any increment from zero to one hundred percent, the percentage of budget proposals and payment applications which will be selected for automated review and approval of the proposed quantities, and including at least one of the following:
wherein, if the selected budget proposal or payment application contains tasks and resources which are at or below an acceptable quantity, then those tasks and resources are auto-approved; and
wherein, if the selected budget proposal or payment application does not contain other information that requires manual review, then the budget proposal or payment application is automatically reviewed and approved, from receipt to notification of approval, without manual intervention or involvement.

10. The system of claim 4 wherein the computer-executable instructions include instructions to enable reporting of data to support a pricing incentive program.

11. The system of claim 4 wherein the computer-executable instructions include instructions to exclude selected submissions from automatic review processes and subjecting them to manual review.

12. The system of claim 4 wherein the instructions include at least one of the following:
maintaining a database of certifying professionals who are permitted to validate budget proposals and payment applications;
maintaining a database of site owners who are permitted to validate budget proposals and payment applications;
checking a budget proposal as to whether it will exceed limits for potential reimbursement per incident;
checking a payment application as to whether it will exceed limits for actual payment per year;
requiring documentation supplemental to the submittal of a budget proposal or payment application be entered into the system before the proposal or application is submitted and reviewed; and
automated application and approval of handling charges to expedite the review process, to ensure accurate calculation, and to remove from view certain data.

13. The system of claim 4 wherein the instructions include at least one of the following:
removing unit and extended cost data from the technical reviewer's view;
removing quantity and extended cost data from the accounting reviewer's view;
collecting reviewer comments on modifications and rejections of proposed items;
removing from the accounting and technical reviewers' view items which do not require their pricing review;
withdrawing at the consultant's request a budget proposal or payment application from review without creating an invalid corresponding response record; and
maintaining multiple approved budget records per incident and phase of work to determine the total approved budget at any time, and to determine what quantity balances remain on a given budget at any time.

14. The system of claim 4 wherein the instructions include at least one of the following:
amending approved budgets to reflect payment application review actions and/or appeals board actions including at least one of (1) changes in approved pricing, (2) changes in approved quantities, (3) the allowance of non-standard tasks, (4) the allowance of non-budgeted tasks and (5) the allowance of non-budgeted resources;
generating receipts acknowledging the receipt of budget proposals and payment applications; and
generating reviews incorporating the comments and/or justifications for modifications and/or rejections of submitted items.

15. The system of claim 4 wherein the instructions include at least one of the following:
including appeals documentation that amends budgets based on appeals board actions;
projecting cash flow based on budget and payment application data; and
interfacing with payment systems to generate payments.

16. One or more computer-readable media having computer executable components executed by a computing device, said components comprising:
A web-based module for creating and submitting proposals;
A web-based module for receiving proposals including tasks, for receiving payment applications for partially completed tasks of the proposal, for receiving payment applications for completed tasks of the proposals and for reviewing and approving received proposals; and
A management module for monitoring received proposals and for responding to received payment applications.

17. The media of claim 16 wherein the web-based module comprises instructions for:
maintaining a database of certifying professionals who are permitted to validate budget proposals and payment applications;
maintaining a database of site owners who are permitted to validate budget proposals and payment applications;
checking a budget proposal as to whether it will exceed limits for potential reimbursement per incident;
checking a payment application as to whether it will exceed limits for actual payment per year;
requiring documentation supplemental to the submittal of a budget proposal or payment application be entered into the system before the proposal or application is submitted and reviewed; and
automated application and approval of handling charges to expedite the review process, to ensure accurate calculation, and to remove from view certain data.

18. The media of claim 16 wherein the review module comprises instructions for at least one of the following:
defining a schedule including a work breakdown structure (WBS) based on market data maintained and periodically updated and including a standard resource schedule (SRS) based on market data maintained and periodically updated;
defining a task to include minimum quantities (EQ) based on market data;
defining a task to include minimum unit pricing (EUP) based on market data;
defining a task to include total task pricing (EEP) for eliminating line-item review;
defining a task to include maximum unit pricing (ERR) based on market data;
defining a task to include budget-specific expedited values (BSEV) including new budget proposals and/or payment applications; and
defining non-standardized tasks to define a schedule and to collect non-standardized resource data allowing for non-standard tasks and resources.

19. The media of claim 16 wherein the management module comprises instructions for:
removing unit and extended cost data from the technical reviewer's view;
removing quantity and extended cost data from the accounting reviewer's view;
collecting reviewer comments on modifications and rejections of proposed items;
removing from the accounting and technical reviewers' view items which do not require unit pricing review;
withdrawing at the consultant's request a budget proposal or payment application from review without creating an invalid corresponding response record; and
maintaining multiple approved budget records per incident and phase of work to determine the total approved budget at any time, and to determine what quantity balances remain on a given budget at any time.

20. A computerized method for managing cost containment within a plurality of projects, said method comprising:
defining standardized tasks for each of the projects; defining a schedule for standardized tasks;
collecting resource data including pricing data for each of the standardized tasks; and
based on the defined schedule and the collected data, developing multi-tiered reimbursement/payment price milestones for each project.
